(19) United States
(12) Patent Application Publication
(10) Pub. No.: US 2024/0296991 A1
(43) Pub. Date: Sep. 5, 2024

(54) INTEGRATED MATRIX TRANSFORMER FOR A POINT-OF-LOAD CONVERTER, AND APPLICATIONS THEREOF

(71) Applicant: The Research Foundation for The State University of new York, Binghamton, NY (US)

(72) Inventors: Tuhin Subhra Sasmal, Binghamton, NY (US); Pritam Das, Vestal, NY (US)

(21) Appl. No.: 18/442,000

(22) Filed: Feb. 14, 2024

Related U.S. Application Data
(60) Provisional application No. 63/485,229, filed on Feb. 15, 2023.

(51) Int. Cl. H01F 27/28; H01F 27/24

(52) U.S. Cl. CPC H01F 27/2804; H01F 27/24

(57) ABSTRACT

An integrated matrix transformer for point-of-load converters is provided. The matrix transformer has a smaller surface area and a reduced core volume that lowers core losses. The matrix transformer's winding pattern produces a larger magnetizing inductance which aids in attaining better accuracy for gate pulse generation on the synchronous side of a point-of-load converter and mitigates power reversal issues present in traditional point-of-load converters using traditional matrix transformers. A reduction of circulating current in the primary side is also achieved. The matrix transformer comprises: a plurality of elemental transformers, each elemental transformer comprising a core, primary and secondary, linked through upper and lower members. The elemental transformers are magnetically coupled through the upper and lower members such that a flux induced by primary has a return path through one other core. The primaries are wired in series, and the secondaries in parallel.

### CROSS REFERENCE TO RELATED APPLICATIONS

The present application is a Non-provisional of, and claims benefit under 35 U.S.C. § 119(c) from, U.S. Provisional Patent Application No. 63/485,229, filed Feb. 15, 2023, the entirety of which is expressly incorporated herein by reference.

### FIELD OF THE INVENTION

The present disclosure relates to power converters. More particularly, it relates to a matrix transformer for a point-of-load converter, and applications thereof.

### BACKGROUND OF THE INVENTION

The proliferation of personal computers, smart phones, and internet services, as well as a move to cloud computing, has led to a large increase in the number of data centers and the energy consumed by these data centers. This increased energy consumption is driving a need for more efficient point-of-load power converters to power the servers in these data centers.

With the advancement of digital content demand in daily life big data processing and cloud computing has extended power demand of data centers across the globe. High performance multicore processors are one of the reasons of this quick raise in energy consumption. In data center, DC power supply architecture of 12 V source is replaced by 48 V to keep down the inevitable resistive loss. On the contrary, at the output end, voltage requirement for computer pieces like CPU and GPU in new motherboard architecture is falling slowly to 1 V or sub one Volt (1). This is an attempt to reduce dynamic power consumption of the logic gates in CPU as the power consumption is proportional to square of the input voltage to CPU (2). This draws the attention to make a 48 V to 1.2 V or 1 V or sub-one voltage regulator module (VRM) to supply power to the computing load. This leads to two major challenges: high step down of input voltage; and high current demand at the load end to satisfy high power demand of server system. Various strategies have been incorporated in the aim to satisfy the load end specifications for Point of Load (POL) applications. All these attempts are mainly classified into two groups: switched-capacitor (SC) converter and resonant tank converter.

Despite the compactness switched capacitor converters can offer, accomplishment of high step-down of source voltage using multiple switching capacitor stages degrade the overall efficiency (1),(3). On the other hand, with resonant power converters both high efficiency and very high-power density can be achieved because of inherent natural soft switching due to the resonant tank operation. Two stage and single stage converter are adopted to satisfy the server system load demand.

In (4), VICOR introduced an inductive link dc-dc converter to generate an intermediate voltage level and then followed by a resonant tank stage. In another approach, an LLC resonant converter to achieve high step down followed by a multiphase buck converter to facilitate large current demand is introduced. Multiphase inductors with large current capability eventually make the system bulky. Also, a two-stage design degrades overall converter efficiency. In the case of single stage approach, a transformer with a high turns ratio to step down input voltage followed by a current doubler at the secondary rectifier side to meet load current demand is another option for a PoL application. But, current-doubler circuits need extra circuit components at high frequency to mitigate high frequency oscillations at the secondary stage. A single stage LLC resonant circuit at the primary side and a synchronous rectifier at the secondary side is a viable option. An inductive link half-bridge at the primary end and center tapped secondary side converter for rectification is a viable option. In all these cases, secondary windings need to carry a large current. This needs multiple devices in parallel to share the total current during synchronous rectification. With multiple devices, it is difficult to achieve equal current sharing among the devices of same leg. Large currents also lead to large winding termination loss at the secondary. Large leakage inductance as a reason of poor coupling in high turns ratio transformers and large ac resistance causes extra losses in single core geometry of the transformer. This single entity decides the height of the transformer. Large secondary side loop inductances cause large voltage oscillations across the secondary side devices with high frequency converter operation. Thermal management becomes difficult. To solve all these problems, a matrix transformer is incorporated in low voltage high current applications (6)-(14). Overall, it also assists in achieving a low-profile high-power density converter.

Different types of matrix transformer have been adopted in literature. A 2×4 matrix transformer is adopted to distribute all the load demand across each elemental transformer (5), (6). But at the extreme limit, the transformer core needs to be customized separately. Two different types of core limbs are used to construct the whole matrix transformer. In (7), a conventional available ‘E’ core is used to achieve the matrix transformer. Here, no flux cancellation is accommodated. Hence, core volume and footprint reduction are not achieved. This problem has been addressed by accomplishing flux cancellation in (8), (9), (10), (11), (12), (13), (14), (15), (16). In (9), (10), which distribute a high input current to the primary winding using two matrix transformers in parallel, which makes effective magnetizing inductance, Lₘ, scaled down. This increases circulating current, which eventually increases the device rating of the primary side. This difficulty can be solved by connecting all the elemental transformers in series as demonstrated in (11), (12), (13). Here, all the limbs are placed at equal distance. The flux of each elemental transformer is distributed to its adjacent core. Though this assists in achieving higher magnetizing inductance, to enhance light load efficiency, further circulating current reduction is required. In (15), a matrix transformer is used to step up input voltage along with transformer window area reduction. But for high current applications, this type of secondary winding incurs huge winding termination loss. While paralleling all the secondary windings, any mismatch in flux linkage among elemental transformers causes a different voltage across each secondary terminal. This leads to a circulating current at output end. This problem is addressed in (16). But due to a greater number of air gaps and core geometry, this also lacks in attaining higher Lₘ.

In case of high current application thermal management, secondary winding termination loss and equal current sharing among the secondary side devices become difficult with a single transformer. Also, with high stepping down of input voltage which is an integral part of recent power distribution architectures in server systems, leakage inductance and higher ac resistance of the windings are difficult to mitigate.

To solve these issues use of a matrix transformer is common practice. In matrix transformer configuration, multiple elemental transformers are magnetically coupled to form a single entity. Individually, each elemental transformer shares inter-wired primary and secondary windings of the single transformer. Modification of magnetic core geometry and flux distribution are described in FIGS. 14A-14C. In FIG. 14A, a cross sectional view of a single transformer with an E-E type core is shown. The primary winding current direction and flux direction according to right hand rule are depicted. Flux distribution clearly depicts that total flux of the center leg is shared equally to the two side legs. To maintain the same flux density, the cross-section area of center leg, CM, is equal to the total area of left leg, CL, and right leg, CR. The cross-section area of two side legs are equal. Now, the primary winding is split into two windings and placed around two side legs of the transformer, as shown in the FIG. 14B. Here, with this type of winding pattern, the center leg is still required to complete the flux path. In the next stage, windings are re-winded and flux in the center leg cancel out each other as depicted in FIG. 14C.

So, with the absence of a center leg of the transformer, two side legs form two elemental transformers. These two elemental transformers jointly establish a matrix transformer as shown in FIG. 14D. Hence, reduction of overall cross-sectional area of the matrix transformer is attained in comparison to the single transformer. As discussed above, the high step-down transformer is essential for server systems. This is realized by connecting primary windings of the elemental transformer in series. Also, a larger current requirement at the load end demands parallel connection of secondary windings of elemental transformers. This helps reducing effective leakage inductance.

For example, one 4:1 turns ratio transformer is split into two 2:1 turns ratio transformers as shown in the FIGS. 15A-15B. A simplified equivalent circuit of single transformer and matrix transformer are shown in FIG. 15A and FIG. 15B respectively. In a matrix transformer, two primary windings and secondary windings are connected in series and parallel respectively. This, in turn, makes individual leakage inductances of the matrix transformer in parallel. Also, effective resistance is reduced in comparison to a single transformer. As current in the secondary sides are shared by the devices, it is easy to share equally among the devices. Also, it helps in attaining smaller termination loss and better interleaving which further reduces leakage inductance and ac resistance at high frequency.

So far, different types of matrix transformer have been proposed in the literature. The overall effect of magnetizing inductance due to magnetic coupling among elemental transformers has not been discussed. Since circulating current is inversely proportional to the overall magnetizing inductance, it is essential to investigate the impact on total magnetizing inductance due to the replacement of traditional transformer with matrix transformer in various topologies like the push pull converter (17), multiphase buck converter (18), etc. With a higher power rating, more than two elemental transformers are used in a matrix transformer. An even number of elemental transformers are required to make a closed magnetic path and uniform flux distribution.

Recently, a four-pillar matrix transformer configuration is introduced in research papers (9), (10), (11)-(13). In (9), (10) the winding pattern effectively makes magnetizing inductances in parallel, which reduces the effective magnetizing inductance of the matrix transformer. In (11)-(13), windings of individual transformers are in series, hence the magnetizing inductances are in series and flux distribution of the transformer is shown in FIG. 16. Here, only the bottom half of the core geometry is displayed. The geometry of the top half is same as the bottom half. Four cylindrical pillars formed individual elemental transformers, and one plate on the bottom is connected to couple the transformer arrays magnetically. Current directions through individual primary windings are depicted by ‘dot’ and ‘cross’ notation. Windings are not shown, but it is considered that windings are around the individual pillars and in parallel to the plate. Here, it is assumed that each winding is of two turns. All the pillars A, B, C and D have the same flux density. The magnetizing inductance calculation seems complex, since all the elemental transformers are magnetically coupled through different flux paths as shown in the FIG. 16.

To decouple all the flux paths, one approach is adopted as exhibited in FIG. 17. Here, only the flux lines of limb B are shown linked with the half of the adjacent limbs A and C explicitly. Here, it is visible that flux lines of limb B make a complete path alongside the adjacent half parts of pillar A and C through the top and bottom plates of transformer. For further simplification, limb B can be considered on the same line and in between two halves of the limbs A and C.

A complete cross-sectional view of pillar B along with the other halves of pillar are shown in FIG. 18. Pillar, B, is halved by a dashed line to further decouple the magnetic path of pillar B and two separate magnetic paths are realized to facilitate magnetizing inductance calculation. The left half of B and half of A make a complete magnetic path. Similarly, right half of B and half of C make a complete magnetic path. Magnetizing inductance of a transformer is calculated by keeping open secondary winding terminals. One turn of the winding of pillar B is in series with the turn of the winding of pillar A along the magnetic path, hence these two turns result in inductance, Lₘ₁ according to the following formula,

$${L}_{m 1} = {n}^{2} / \qquad ( 1 )$$

where N and [symbol] are the number of turns and reluctance respectively. Similarly, one turn around pillar C, and one turn of winding of pillar B, contribute an inductance Lₘ₂. Similarly, half of pillar A and C together with pillar D form two magnetic paths. These two magnetic paths separately offer two inductances of Lₘ₃ and Lₘ₄. Since all windings are in series, the total equivalent inductance is the summation of Lₘ₁, Lₘ₂, Lₘ₃ and Lₘ₄. Considering symmetry, all individual inductance is of same value of Lₘₐ with two turns. Hence, the total inductance is four times Lₘₐ i.e.,

[symbol]

### REFERENCES

(Each of which is expressly incorporated herein by reference in its entirety).
(1) Li, Yanchao, Xiaofeng Lyu, Dong Cao, Shuai Jiang, and Chenhao Nan. “A 98.55% efficiency switched-tank converter for data center application.” IEEE Transactions on Industry Applications 54, no. 6 (2018): 6205-6222.
(2) Enhanced Intel@ Speed Step@ Technology for the Intel@ Pentium® M Processor, March 2004. Available: download.intel.com/design/network/papers/30117401.pdf
(3) Jiang et al., “Switched Tank Converter”, U.S. Pat. No. 9,917,517 B1; Date of Patent: Mar. 13, 2018.
(4) Khatua, Somnath, Debaprasad Kastha, and Santanu Kapat. “A new single-stage 48-V-input VRM topology using an isolated stacked half-bridge converter.” IEEE Transactions on Power Electronics 35, no. 11 (2020): 11976-11987.
(5) Ngo, Khai DT, E. Alpizar, and J. Kenneth Watson. “Modeling of magnetizing inductance and leakage inductance in a matrix transformer.” IEEE transactions on power electronics 8, no. 2 (1993): 200-207, doi: 10.1109/63.223972.
(6) K. D. T. Ngo, E. Alpizar and J. K. Watson, “Modeling of losses in a sandwiched-winding matrix transformer,” in IEEE Transactions on Power Electronics, vol. 10, no. 4, pp. 427-434, July 1995, doi: 10.1109/63.391940.
(7) Dai, Mingcong, Xiangjun Zhang, Hui Li, Dibin Zhou, Yijie Wang, and Dianguo Xu. “LLC converter with an integrated planar matrix transformer based on variable width winding.” In 2019 22nd International Conference on Electrical Machines and Systems (ICEMS), pp. 1-4. IEEE, 2019, doi: 10.1109/ICEMS.2019.8922483.
(8) Ahmed, Mohamed H., Chao Fei, Fred C. Lee, and Qiang Li. “48-V voltage regulator module with PCB winding matrix transformer for future data centers.” IEEE Transactions on Industrial Electronics 64, no. 12 (2017): 9302-9310, doi: 10.1109/TIE.2017.2711519.
(9) Ahmed, Mohamed H., Fred C. Lee, and Qiang Li. “LLC converter with integrated magnetics application for 48V rack architecture in future data centers.” In 2019 IEEE Conference on Power Electronics and Renewable Energy (CPERE), pp. 437-443. IEEE, 2019, doi: 10.1109/CPERE45374.2019.8980022.
(10) Ahmed, Mohamed H., Ahmed Nabih, Fred C. Lee, and Qiang Li. “High-efficiency, high-density isolated/regulated 48V bus converter with a novel planar magnetic structure.” In 2019 IEEE Applied Power Electronics Conference and Exposition (APEC), pp. 468-475. IEEE, 2019, doi: 10.1109/APEC.2019.8722216.
(11) Fei, Chao, Fred C. Lee, and Qiang Li. “High-efficiency high-power-density LLC converter with an integrated planar matrix transformer for high-output current applications.” IEEE Transactions on Industrial Electronics 64, no. 11 (2017): 9072-9082, doi: 10.1109/TIE.2017.2674599.
(12) Fei, Chao, Fred C. Lee, and Qiang Li. “High-efficiency high-power-density 380V/12V DC/DC converter with a novel matrix transformer.” In 2017 IEEE Applied Power Electronics Conference and Exposition (APEC), pp. 2428-2435. IEEE, 2017, doi: 10.1109/APEC.2017.7931039.
(13) Fei, Chao, Yuchen Yang, Qiang Li, and Fred C. Lee. “Shielding technique for planar matrix transformers to suppress common-mode EMI noise and improve efficiency.” IEEE Transactions on Industrial Electronics 65, no. 2 (2017): 1263-1272, doi: 10.1109/TIE.2017.2733473.
(14) Huang, Daocheng, Shu Ji, and Fred C. Lee. “LLC resonant converter with matrix transformer.” IEEE Transactions on Power Electronics 29, no. 8 (2013): 4339-4347, doi: 10.1109/TPEL.2013.2292676.
(15) Bortis, Dominik, Juergen Biela, and Johann W. Kolar. “Transient behavior of solid-state modulators with matrix transformers.” IEEE Transactions on Plasma Science 38, no. 10 (2010): 2785-2792., doi: 10.1109/TPS.2010.2065243.
(16) Knabben, Gustavo Carlos, Jannik Schafer, Luca Peluso, Johann W. Kolar, M. J. Kasper, and Gerald Deboy. “New PCB winding” snake-core” matrix transformer for ultra-compact wide DC input voltage range hybrid B+ DCM resonant server power supply.” In 2018 IEEE International Power Electronics and Application Conference and Exposition (PEAC), pp. 1-6. IEEE, 2018, doi: 10.1109/PEAC.2018.8590430.
(17) Lai, R-S., Khai DT Ngo, and J. Kenneth Watson. “Steady-state analysis of the symmetrical push-pull power converter employing a matrix transformer.” IEEE transactions on power electronics 7, no. 1 (1992): 44-53, doi: 10.1109/63.124576
(18) Wei, Jia, and Fred C. Lee. “Two novel soft-switched, high frequency, high-efficiency, non-isolated Voltage Regulators-the phase-shift buck converter and the matrix-transformer phase-buck converter.” IEEE Transactions on Power Electronics 20, no. 2 (2005): 292-299, doi: 10.1109/TPEL.2004.843014.
(19) Sasmal, Tuhin Subhra, Kalyan Yenduri, and Pritam Das. “Single-stage saturable inductive-link half-bridge point of load converter.” In 2021 IEEE Energy Conversion Congress and Exposition (ECCE), pp. 2042-2047. IEEE, 2021, doi: 10.1109/ECCE47101.2021.9595359.
AT-46226; AU-2004201338; AU-2004201338; AU-2004201441; AU-2004201441; AU-20042014419; AU-2004237881; AU-2004237881; AU-2005237178; AU-2005237178; AU-2015377931; AU-2016208411; AU-2016208411; AU-2019200278; AU-2019200278; AU-2019277274; AU-3537589; AU-3751189; AU-4003897; AU-5731190; AU-613211; AU-613211; AU-6538790; AU-6637890; AU-705755; AU-724362; AU-7856291; AU-PO2117960; AU-PO211796-DO; AU-PO5532970; AU-PO553297-DO; BR-112017014921; BR-112021011225; BR-122020016581; BR-8906934; BR-8906942; BR-PI0501726; CA-2256561; CA-2461590; CA-2462464; CA-2488314; CA-2506051; CA-2506051; CA-3060438; CA-3060438; CH-702974; CN-100398244; CN-100576378; CN-101055788; CN-101075786; CN-101075786; CN-101272099; CN-101719718; CN-103004070; CN-103004070; CN-103178720; CN-104331544; CN-104552848; CN-105374537; CN-105493210; CN-105720840; CN-105720840; CN-106537732; CN-106537732; CN-106557770; CN-107078626; CN-107078626; CN-107123523; CN-107123523; CN-107231097; CN-107231097; CN-107492365; CN-108092523; CN-108110859; CN-108122664; CN-108694270; CN-109063408; CN-109063408; CN-109478840; CN-1095927; CN-109841398; CN-110045236; CN-110061636; CN-110069883; CN-110161344; CN-110266194; CN-110445390; CN-110445390; CN-110553724; CN-110574272; CN-110729905; CN-110828126; CN-110914944; CN-110914944; CN-110915204; CN-110915204; CN-111199492; CN-111431422; CN-111555345; CN-111566763; CN-111566763; CN-111864746; CN-111883351; CN-111987923; CN-112491282; CN-112562983; CN-112562983; CN-112652439; CN-112886821; CN-113098286; CN-113098286; CN-113199941; CN-113205951; CN-113363061; CN-113363061; CN-113394967; CN-113408623; CN-113408623; CN-113517120; CN-113517120; CN-113746331; CN-113809904; CN-113871156; CN-113871173; CN-113946199; CN-113949273; CN-113950727; CN-113965091; CN-113990300; CN-113990300; CN-114093620; CN-114093620; CN-114270458; CN-114400136; CN-114499193; CN-114649952; CN-114758858; CN-114844359; CN-114884309; CN-114915177; CN-114925548; CN-114928250; CN-114974802; CN-115020079; CN-115053305; CN-115223782; CN-115566913; CN-115589141; CN-115603592; CN-115691974; CN-1222951; CN-1712170; CN-1770335; CN-1794554; CN-1794554; CN-200982566; CN-201523330; CN-202684259; CN-203278663; CN-205724403; CN-206619465; CN-209087505; CN-210780552; CN-211557127; CN-212063514; CN-212258422; CN-212572365; CN-215772922; CN-216391474; CZ-2850066; DE-102016011055; DE-102021003119; DE-102021101845; DE-102022100313; DE-1090887; DE-1286106; DE-1524001; DE-1524001; DE-1524851; DE-2120180003211; DE-3479688-D1; DE-3832476; DE-3832476; DE-602004012806; EA-038845; EP-0157867; EP-0157867; EP-0317623; EP-0370102; EP-03701024; EP-0377691; EP-03776914; EP-0425574; EP-0906498; EP-0923800; EP-0932168; EP-1333553; EP-1333564; EP-1333565; EP-1333566; EP-1333567; EP-1406373; EP-1495826; EP-1495826; EP-1496527; EP-1496527; EP-1536435; EP-1603259; EP-1603259; EP-1606974; EP-1609553; EP-1609553; EP-1644944; EP-1675139; EP-16751393; EP-1675139; EP-1714449; EP-1714449; EP-2154851; EP-21548513; EP-2375560; EP-2375560; EP-2577854; EP-3120360; EP-3138184; EP-3138184; EP-3190595; EP-3202032; EP-3245527; EP-3245527; EP-3316469; EP-3474300; EP-3474300; EP-3564975; EP-3599692; EP-3599692; EP-3616225; EP-3879684; EP-4036941; EP-4066267; EP-4071774; FR-2621146; FR-2852779; GB-2210229; GB-2508942; GB-2543123; HU-212690; IN-2012CN10041; IN-201617035836; IN-201717024605; IN-201931018283; IN-201937047832; JP-2000500207; JP-2000505602; JP-2002237423; JP-2004031957; JP-2004159485; JP-2004173483; JP-2005028450; JP-2005033183; JP-2005203744; JP-2006007313; JP-2006179456; JP-2007229897; JP-2007520971; JP-2008524978; JP-2011504001; JP-2012178628; JP-2015109756; JP-2020518060; JP-2021108159; JP-2021136362; JP-2022086183; JP-2023504037; JP-3237697; JP-3311391; JP-3417161; JP-3460428; JP-3863977; JP-3973644; JP-4246106; JP-4246146; JP-4518329; JP-4876246; JP-5022910; JP-5175853; JP-5228058; JP-5522693; JP-5983587; JP-6860695; JP-7142122; JP-H02287909; JP-H03500948; JP-H03501430; JP-H06332939; JP-H0693753; JP-H09219828; JP-H0998445; JP-H1075209; JP-S61500097; JP-S6473885; KR-100436872; KR-100639136; KR-100650421; KR-100695379; KR-100702459; KR-101501168; KR-101527441; KR-101559294; KR-101657523; KR-101657773; KR-101751350; KR-101778552; KR-101939665; KR-101977823; KR-102358278; KR-102427584; KR-102436351; KR-20010012173; KR-20010112278; KR-20050007111; KR-20050008473; KR-20060073418; KR-20100054075; KR-20110046234; KR-20110046329; KR-20150019088; KR-20160035317; KR-20170006587; KR-20170088721; KR-20170118073; KR-20180122369; KR-20190137883; KR-20220014932; KR-20220116199; KR-20220147849; KR-890000950; KR-900019075; KR-900701021; KR-900701081; MX-PA04003990; MX-PA04004130; MX-PA05006101; PL-204643; RU-1333461; RU-1805411; RU-2005110970; RU-2010154468; RU-2014149238; RU-2019120515; RU-2074432; RU-2120876; RU-2248565; RU-2290664; RU-2293981; RU-2374751; RU-2538316; RU-2577938; RU-2629237; RU-2638967; RU-2729394; RU-2743280; RU-94035585; SK-2806676; SU-1037156; SU-1260834; SU-1305873; SU-200794; SU-248774; SU-312386; SU-338900; SU-402867; SU-451207; SU-546119; SU-568112; SU-750755; SU-859904; TW-200621408; TW-200933161; TW-201543511; TW-201830421; TW-297904; TW-1271256; TW-I280169; TW-I361573; TW-I632569; TW-I663611; TW-M440580; UA-33713; UA-67311; UA-84806; U.S. Ser. No. 10/074,474; U.S. Ser. No. 10/284,093; U.S. Ser. No. 10/389,199; U.S. Ser. No. 10/483,032; U.S. Ser. No. 10/635,965; U.S. Ser. No. 10/699,286; U.S. Ser. No. 10/778,107; U.S. Ser. No. 10/847,297; U.S. Ser. No. 10/910,140; U.S. Ser. No. 10/914,778; U.S. Ser. No. 10/937,590; U.S. Ser. No. 10/956,810; U.S. Ser. No. 11/021,069; U.S. Ser. No. 11/152,854; U.S. Ser. No. 11/271,490; U.S. Ser. No. 11/362,585; U.S. Ser. No. 11/367,565; U.S. Ser. No. 11/496,045; U.S. Ser. No. 11/544,537; US-20020075119; US-20030142513; US-20030227280; US-20030234714; US-20040174147; US-20040183513; US-20040184289; US-20040232899; US-20040257187; US-20050006364; US-20050006366; US-20050006367; US-20050110606; US-20050145611; US-20050219275; US-20050232133; US-20050236374; US-20050242916; US-20050286271; US-20060076329; US-20060215841; US-20070160010; US-20070211816; US-20070229206; US-20070267393; US-20080150664; US-20080152222; US-20090252101; US-20100011040; US-20100014606; US-20100117904; US-20100142234; US-20100263795; US-20110101951; US-20110199033; US-20110243793; US-20120157865; US-20130057184; US-20130062958; US-20130216046; US-20130321207; US-20140181171; US-20150155086; US-20160013773; US-20160307695; US-20160379234; US-20170040859; US-20170091956; US-20170117944; US-20170118050; US-20170330678; US-20180003760; US-20180183335; US-20180226182; US-20180308632; US-20190221362; US-20190311242; US-20200083817; US-20200212795; US-20200212807; US-20200350117; US-20200395164; US-20210081975; US-20210217555; US-20210288576; US-20210319288; US-20220076127; US-20220157041; US-20220172880; US-20220215052; US-20220223336; US-20220230797; US-20220238268; US-20220271657; US-20220279014; US-20220319769; US-20220321016; US-20220328235; US-20220385198; US-20230017789; U.S. Pat. Nos. 4,449,201; 4,464,726; 4,633,470; 4,665,357; 4,845,606; 4,907,087; 4,942,353; 4,978,906; 5,054,103; 5,093,646; 5,414,609; 5,479,146; 5,555,494; 5,726,682; 5,757,974; 5,982,645; 5,999,078; 6,026,792; 6,097,395; 6,121,761; 6,137,392; 6,433,299; 6,578,253; 6,734,778; 6,758,399; 6,844,802; 6,911,848; 6,930,893; 6,934,166; 6,975,098; 6,979,982; 6,984,965; 6,995,337; 6,998,573; 7,023,317; 7,071,807; 7,098,638; 7,119,648; 7,145,786; 7,187,263; 7,274,000; 7,292,126; 7,336,288; 7,362,206; 7,479,863; 7,564,706; 7,573,000; 7,613,305; 7,737,382; 7,796,005; 7,924,958; 7,940,537; 8,009,598; 8,160,182; 8,165,420; 8,213,198; 8,331,475; 8,345,887; 8,705,757; 8,761,405; 8,774,301; 8,779,979; 8,903,025; 8,963,459; 9,031,145; 9,263,981; 9,741,133; 9,887,627; 9,929,884; 9,960,683; 9,979,449; WO-1985001625; WO-1988010045; WO-1989010621; WO-1989010654; WO-1990001232; WO-1990013939; WO-1991005355; WO-1991006201; WO-1991017556; WO-1994005076; WO-1995001669; WO-1997048891; WO-1998010498; WO-2004086818; WO-2004114499; WO-2005076555; WO-2007100215; WO-2011153106; WO-2012087702; WO-2014091198; WO-2014105260; WO-2015142961; WO-2015166188; WO-2016113072; WO-2016206269; WO-2017068405; WO-2017069880; WO-2018200506; WO-2019052620; WO-2019227179; WO-2020088245; WO-2020252251; WO-2021072790; WO-2021073121; WO-2021105369; WO-2021211194; WO-2022006691; WO-2022055572; WO-2022062707; WO-2022108604; WO-2022150401; WO-2022187283; WO-2022213566; and WO-2022263221.

### SUMMARY OF THE INVENTION

An integrated matrix transformer for point-of-load converters and applications thereof is provided. The matrix transformer has a smaller surface area and a reduce core volume that lowers core losses. The matrix transformer's winding pattern produces a larger magnetizing inductance which aids in attaining better accuracy for gate pulse generation on the synchronous side of a point-of-load converter and mitigates power reversal issues present in traditional point-of-load converters using traditional matrix transformers. A reduction of circulating current in the primary side is also achieved.

A different approach from that of the prior art, for matrix transformer design for point of load (PoL) converter applications facilitating higher magnetizing inductance is provided by the present technology. The core geometry not only occupies smaller surface area but also reduces core volume hence core loss. Circulating current in the primary and secondary side are also reduced. The efficacy of configuration for low voltage high power application is achieved without affecting mechanical stability of the magnetics.

In comparison to the various proposals discussed in the art, the present technology adopts a different approach for matrix transformer design, which facilitates achievement of higher magnetizing inductance. This aids in synchronous rectification for a point of load converter. The core geometry according to the present technology not only occupies smaller surface area but also reduces core volume hence core loss.

In an embodiment of the present invention, a matrix transformer is presented which includes an X-shaped magnetic base, a first magnetic pillar and a second magnetic pillar coupled to the magnetic base, and an X-shaped magnetic cap coupled to the first magnetic pillar and the second magnetic pillar. A flux from the magnetic base passing through the first magnetic pillar has a return path to the magnet base through the second magnetic pillar.

In embodiments, the matrix transformer includes a third magnetic pillar and a fourth magnetic pillar coupled to the magnetic base, and a flux from the magnetic base passing through the third magnetic pillar has a return path to the magnet base through the fourth magnetic pillar.

In one embodiment, a matrix transformer is presented in which the magnetic base and the magnetic cap each have four concave sides.

In another embodiment, a matrix transformer has a magnetic base and a magnetic cap that are square or rectangular.

According to the present technology, there is a provision to increase mutual inductance further as shown in the FIG. 19. Here, all windings are connected in series, since it helps increase overall magnetizing inductance. But, the technology modifies the windings pattern such that the flux of one pillar is shared with only one adjacent limb, and not with the two adjacent limbs. Here, flux of limb B completes its path through limb C only. Similarly, the flux of limb A passes through limb D only. All primary windings of the individual elemental transformers are of the same two turns as before. Current directions through these windings are shown by ‘dot’ and ‘cross’ notation and accordingly the flux direction is indicated. Since the magnetic path is completed through two pillars, along with the top and bottom plate only, it is easy to calculate the inductance value.

A cross section view of two pillars B and C with windings are shown in FIG. 20. The total turns along the magnetic path is four, including pillar B and C. The corresponding inductance is [symbol] . Likewise, pillars A and D contribute the same value of inductance. Since the primary windings are connected in series, the total inductance value is [symbol] . Hence, the proposed pattern offers two times the magnetizing inductance in compared to (11)-(13) with same number of total turns. Also, flux density of each pillar is same as in (11)-(13).

Since, core loss is proportional with core volume, a modification of the approach to the core geometry, which helps reduce the overall matrix transformer core volume is shown in FIG. 7. Here, the bottom half of the matrix transformer is visible. It is clear that with the same aforementioned winding pattern, the magnetic flux of limb, B completes its path through limb C only. Similarly, the flux through limb A completes its path through limb D only. Hence, this also offers same magnetizing inductance.

A top view of the matrix transformer and windings with current direction are shown in FIG. 8. It is clear that sections between two adjacent pillars are shaved off and diagonal sections of the core connect among pillars.

The total reduction of volume, V_{red} is:

$${V}_{r e d} = h ( 8 {{W}_{D}}^{2} + 4. 686 {D}_{P} {W}_{D} - 1.3 \; 13 {{D}_{P}}^{2} ) \qquad ( 2 )$$

where, h, W_{D} and D_{P} are thickness of core plate, winding width and diameter of pillar respectively. One thing to be noticed is that with high load demand, W_{D} increases and D_{P} becomes smaller with lower voltage demand at output end. Hence, for PoL applications, the proposed geometry greatly assists in reduction of core volume.

No transformer in power electronics converter is ideal. All have finite magnetizing inductance, Lₘ. This causes a circulating current in the primary side of converter. Point of Load converter (19] with a matrix transformer is depicted in the FIG. 10. Here, Lₘ₁, Lₘ₂, Lₘ₃ and Lₘ₄ are the individual magnetizing inductance of each elemental transformer. For simplicity, it is considered that all the individual elemental transformers are of same magnetizing inductance and the active current component, i_{La} is same through all elemental transformers. Summation of Lₘ₁, Lₘ₂, Lₘ₃ and Lₘ₄ is equal to Lₘₐ. To focus on the effects of Lₘ on the converter, the matrix transformer is represented by an equivalent single transformer and followed by a synchronous rectifier as shown in the FIG. 11. In FIG. 11, Lₘₐ is the magnetizing inductance of the center tap transformer, and i_{Lm} is the magnetizing current flowing through it. Current, i_{La} is an active component responsible for power transfer to the load end. Current, i_{L} is the summation of i_{La} and i_{Lm} and flow through L_{S} and devices, S_{1A}, S_{1B}. This phenomenon not only increases device ratings but also increases switching losses of the primary side, without contributing to any additional power transfer. This incurs a significant degradation of light load efficiency of the converter. Due to high conduction loss in diode rectification, synchronous rectification is preferred in low voltage high current applications.

Circuit waveforms with smaller Lₘ, for the PoL converter (19) is depicted in FIG. 12. With a smaller value of Lₘ, i_{Lm} becomes significant which leads to asynchronous switching instants between primary and secondary side devices, particularly in an LLC converter. This leads to challenges in generation of synchronous rectification gate-pulses. Many solutions have been published in the academic literature to address this issue, but all of them are complex, lossy and expensive.

In (19), a much simpler approach is incorporated. Here, synchronous side gate pulses are generated by sensing the comparatively smaller series inductor current i_{L} only. While i_{L} is positive, S_{2A} and S_{2B} are turned-on and turned-off respectively. On the other hand, when i_{L} is negative S_{2B} and S_{2A} are turned-on and turned-off respectively. Details of the circuit waveforms of converter in FIG. 11 are described in FIG. 12. The circuit consists of a half-bridge converter followed by a synchronous rectifier at the output end. L_{S} is the series inductor; and dc link capacitors, C₁ and C₂ have the voltages of V₁ and V₂ respectively. Together they are connected in series across the input voltage, V_{dc}.

At steady state, V₁ as well as V₂ are same and equal to V_{c}. At the output end, a capacitor C₀ is connected across the load, R₀. G_{1A}, G_{1B}, G_{2A} and G_{2B} are the gate pulses to the switches S_{1A}, S_{1B}, S_{2A} and S_{2B} respectively.

Circuit operation and waveforms are described in details in (19). In this paper, the impact on synchronous rectification gate pulse generation with a smaller value of Lₘ is highlighted. Flow of reverse direction current is illustrated in two situations.

Case I (t₂-t₃): At time to, current i_{L} starts increasing with a fixed positive slope (19) and at time t₁, it starts decreasing with a fixed negative slope and becomes zero at t₃. Since current i_{L} is the summation of i_{La} and i_{Lm}, the active component current i_{La} becomes zero at time t₂. After time t₂, this becomes negative and keeps on decreasing with the same slope until it becomes equal to the absolute value of i_{Lm}. Throughout the time period t₀-t₃, gate pulse G_{2A} remains high as it is commanded by i_{L}. As a result, is becomes negative during the interval t₂-t₃. This induces a large mismatch between the zero crossing of i_{La} and i_{L} with smaller Lₘ. Since is is n times i_{L}a(for each elemental transformer) as shown in FIG. 12, it causes a considerable amount of reverse current circulation during this interval.

Case II (t₅-t₆): From the instant t₃, i_{L} starts decreasing with a fixed negative slope (19) and at time t₄ it achieves a maximum negative value. Thereafter, i_{L} starts increasing with a fixed positive slope and becomes zero at t₆. But, current i_{La} becomes zero at time, t₅. After time t₅, it becomes positive and keeps on rising with the same slope until it becomes equal to the absolute value of i_{Lm}. During the time period t₃-t₆, gate pulse G_{2B} remains high as it is directed by i_{L}. As a result, is remains negative for the interval t₅-t₆. Similar to the previous case, it causes a considerable amount of reverse current circulation during this interval. This way, at the rectifier end, i_{S} flows in a reverse direction for a small duration as shown with dotted box in the FIG. 12. All these lead to extra power demand from the source as well as higher device ratings. Power loss, Pᵣₑᵥ due to reverse current circulation can be expressed as,

$${P}_{r e v} = \frac{{( {n V}_{o} )}^{3} {L}_{s} {T}_{s}}{16 {{L}_{m}}^{2} ( {n V}_{o} + {V}_{dc} / 2 )} \qquad ( 3 )$$

where n, Vₒ, Lₛ, Tₛ and V_{dc} are the turns ratio of transformer, output voltage, series inductance at the primary side, switching time period, and dc input voltage to the converter respectively. Therefore, from (3) it is clear that with the proposed matrix transformer, a reduction of power loss is achieved by four times compared with the traditional matrix transformer (11),(12).

With the aforementioned simpler secondary side gate-pulse generation strategy, zero current switching of synchronous side devices are not achievable with a smaller Lₘ. Turning-off instants of synchronous side gate pulses occur at the actual zero crossing of i_{L} as shown in FIG. 12. With the considerable value of i_{Lm}, i_{S} becomes significant through the devices S_{2A} and S_{2B} during turn-off. This incurs a deviation from soft-switching at the secondary side of the converter. With insignificant values of i_{Lm}, zero crossings of i_{L} do not differ significantly with i_{La}. This results in a simpler and economical solution.

Table I shows a comparison of various matrix transformers, in which the magnetizing inductance is the highest. Here, h and L_{c} are the thickness of the top and bottom plate, and pillar height of each elemental transformer respectively.

An integrated matrix transformer for point of load (PoL) converter applications is provided. The core geometry according to the present technology not only occupies a smaller surface area, but also reduces core volume and hence core loss. A matrix transformer configuration with the described winding pattern offers a larger magnetizing inductance, which aids in attaining accuracy for effective gate pulse generation for synchronous switching, e.g., for rectification. This mitigates the power reversal problem. Reduction of circulating current in the primary is also accomplished. Efficacy of proposed geometry for low voltage high power application is achieved without affecting mechanical stability of the magnetics.

Further features and advantages of the disclosure, as well as the structure and operation of various embodiments, are described in detail below with reference to the accompanying drawings. It is noted that the disclosure is not limited to the specific embodiments described herein. Such embodiments are presented herein for illustrative purposes only. Additional embodiments will be apparent to persons skilled in the relevant art(s) based on the teachings contained herein.

It is an object to provide a matrix transformer, comprising a plurality of elemental transformers comprising an even number of elemental transformers grouped in pairs, each elemental transformer comprising a core, a primary winding and a secondary winding, the primary windings of all the elemental transformers being wired in series and all of the secondary windings being wired in parallel, the cores of the plurality of elemental transformers being magnetically coupled by an upper magnetically permeable member and a lower magnetically permeable member, and the primary windings having a winding polarity such that the flux from the core of one elemental transformer of a pair principally returns through the other core of the respective elemental transformer through the upper magnetically permeable member and the lower magnetically permeable member.

The upper magnetically permeable member and the lower magnetically permeable member may have a uniform cross section area over a range of distances from a respective core. The cross section of the upper magnetically permeable member and the lower magnetically permeable member is preferably below the “knee” of the magnetic saturation curve of the upper and lower magnetically permeable members, e.g., at about 85% of saturation value. Similarly, the cores are preferably operated below saturation. On the other hand, the peak flux is preferably close to the upper limit, to ensure efficiency. Therefore, assuming homogeneous material, the upper and lower magnetically permeable members preferably have a uniform cross section from the junction with the core(s) and the central node, though for manufacturing reasons or the like, a changing cross section is possible. However, it is preferred that the upper and lower magnetically permeable members have, from a top view, concave sides, which reduce mass, and increase efficiency, and facilitates cooling.

A flux from any core of a respective elemental transformer preferably has a return path through only a single other core.

The matrix transformer may have four cores, six cores, eight cores, ten cores, twelve cores, etc. In a six core configuration, the cores may be arranged in a 2×3 layout, with two conjoined X's. In an eight core the layout may be 2×4 array with three conjoined X's, or 3 X's in an L arrangement. In a ten core matrix transformer, the layout may be linear, or T shaped with 4 X's. In a twelve core matrix transformer, the layout may be linear, or T shaped, or “+” shaped, with 5 X's. Further topological layouts as possible, especially with larger numbers of cores.

Each primary winding may have two or more turns, and each secondary may have 1 or more turns.

The upper magnetically permeable member and the lower magnetically permeable member may be “X” shaped, with a respective core disposed at ends of the X shape.

It is therefore an object to provide a matrix transformer, comprising: a plurality of elemental transformers, each elemental transformer comprising a core, a primary winding and a secondary winding, linked through an upper member and a lower member, the primary windings of the elemental transformers being wired in series, and the secondary windings being wired in parallel, the plurality of elemental transformers being magnetically coupled through the upper member and the lower member such that a flux induced by the primary of a respective elemental transformer has a return path through one other core, the matrix transformer having a series primary magnetizing inductance Lₘ corresponding to kn²/ [symbol] , wherein k is a number of cores, n is a number of turns of the primary winding, and [symbol] is a magnetic reluctance.

The upper member and the lower member may have a uniform cross section area over a range of distances from a respective core.

The matrix transformer may have four cores.

Each primary winding may have two turns. Each secondary winding may have one turn.

The upper member and the lower member may have concave edges or be “X” shaped.

A flux from a core of a respective elemental transformer may have a return path through a single other core.

It is also an object to provide a matrix transformer, comprising: an X-shaped magnetic base; a first magnetic pillar coupled to the magnetic base; a second magnetic pillar coupled to the magnetic base; and an X-shaped magnetic cap coupled to the first magnetic pillar and the second magnetic pillar.

A flux from the magnetic base passing through the first magnetic pillar may have a return path to the magnet base through the second magnetic pillar.

The matrix transformer may further comprise a third magnetic pillar coupled to the magnetic base; and a fourth magnetic pillar coupled to the magnetic base. A flux from the magnetic base passing through the third magnetic pillar may have a return path to the magnet base through the fourth magnetic pillar.

The first magnetic pillar may be adjacent to the second magnetic pillar.

The third magnetic pillar may be adjacent to the fourth magnetic pillar.

It is a further object to provide a matrix transformer, comprising: a magnetic base; a first magnetic pillar coupled to the magnetic base; a second magnetic pillar coupled to the magnetic base; and a magnetic cap coupled to the first magnetic pillar and the second magnetic pillar, wherein a flux from the magnetic base passing through the first magnetic pillar has a return path to the magnet base through the second magnetic pillar.

The magnetic base may have four concave side edges. The magnetic base may be X-shaped.

The magnetic cap may have four concave sides. The magnetic cap may be X-shaped.

The matrix transformer may further comprise: a third magnetic pillar coupled to the magnetic base; and a fourth magnetic pillar coupled to the magnetic base.

A flux from the magnetic base passing through the third magnetic pillar may have a return path to the magnet base through the fourth magnetic pillar.

The first magnetic pillar may be adjacent to the second magnetic pillar. the third magnetic pillar may be adjacent to the fourth magnetic pillar.

It is another object to provide a matrix transformer, comprising: a magnetic base; a first magnetic pillar coupled to the magnetic base; a second magnetic pillar coupled to the magnetic base; a third magnetic pillar coupled to the magnetic base; and a fourth magnetic pillar coupled to the magnetic base, wherein the matrix transformer is wound so that a flux from the magnetic base passing through the first magnetic pillar has a return path to the magnet base through the second magnetic pillar, and wherein a flux from the magnetic base passing through the third magnetic pillar has a return path to the magnet base through the fourth magnetic pillar.

The magnetic base may have four concave sides. The magnetic base may be X-shaped.

The matrix transformer may further comprise a magnetic cap coupled to each of the magnetic pillars, wherein the magnetic cap has four concave sides.

The matrix transformer may further comprise a magnetic cap coupled to each of the magnetic pillars, wherein the magnetic cap is X-shaped.

It is an object to provide a matrix transformer, comprising: a set of elemental transformers grouped in pairs, each elemental transformer comprising a core, a primary winding and a secondary winding, the primary windings of all the elemental transformers being wired in series and all of the secondary windings being wired in parallel, the cores of the plurality of elemental transformers being magnetically coupled by an upper magnetically permeable member and a lower magnetically permeable member, and the primary windings having a winding polarity such that flux from the primary winding around one core of a respective elemental transformer principally returns through the upper magnetically permeable member and the lower magnetically permeable member to the other core of the respective elemental transformer.

The upper magnetically permeable member and the lower magnetically permeable member may each have a uniform cross section area over a range of distances from a respective core.

The matrix transformer may have two pairs of elemental transformers and four cores.

Each primary winding may have two turns, and each secondary winding may have 1 or two turns, for example. Non-integral turns may also be provided. The windings may be formed as traces on a printed circuit board or other planar structure. Such a design may be manufactured by linking the pillars to a magnetic base, placing a circuit board having apertures aligned with the pillars over the magnetic base, and placing a magnetic cap over the pillars protruding through the circuit board.

The upper magnetically permeable member and the lower magnetically permeable member may be “X” shaped, with a respective core disposed at an end of leg of the X shape.

A flux from a core of a respective elemental transformer has a return path through a single other core. The return path may be the principal return path (>50%), the substantial return path (>80%), the essential return path (>95%), or other values. The manufacturing tolerances may crease small imbalances that cause flux leakage to other available return paths. In addition, the driving circuit may be controlled to steer currents outside of the flux isolation paradigm.

It is also an object to provide a matrix transformer, comprising a plurality of magnetic pillars; a magnetic base; a magnetic cap; the magnetic base and the magnetic cap forming magnetic circuits comprising the plurality of magnetic pillars; a set of windings wired in series around a first subset of the magnetic pillars, and a set of windings wired in parallel around a second subset of the magnetic pillars, wherein a polarity of the windings, the plurality of magnetic pillars, the magnetic base, and the magnetic cap are together configured such that a flux in one magnetic pillar has a return path substantially through one other magnetic pillar.

The magnetic base may have four concave sides and the magnetic cap has four concave sides. The magnetic base and the magnetic cap may each be X-shaped. Due to possible operation near saturation, and desire for efficiency, the cross section of the arms of the X are preferable uniform, to avoid high concentration of flux in some regions and excess mass.

The matrix transformer may comprise two pairs of elemental transformers each paving a pair of magnetic pillars. The two pairs of elemental transformers may comprise a first magnetic pillar, a second magnetic pillar, a third magnetic pillar, and a fourth magnetic pillar, wherein a flux from the magnetic base passing through the first magnetic pillar has a return path through the magnetic cap and the second magnetic pillar, and a flux from the magnetic base passing through the third magnetic pillar has a return path through the magnetic cap and the fourth magnetic pillar. The first magnetic pillar may be adjacent to the second magnetic pillar and the third magnetic pillar may be adjacent to the fourth magnetic pillar.

The set of windings may comprise circuit board traces.

It is also an object to provide a matrix transformer, comprising: a planar magnetic base, having at least four arms and a central junction region; a plurality of magnetic pillars, a respective magnetic pillar on each arm extending upward from a plane of the planar magnetic base; and a magnetic return, completing a magnetic circuit including the planar magnetic base and the plurality of magnetic pillars, each respective magnetic pillar being surrounded by a wire loop, and being arranged as a plurality of sets of elemental transformers each having a primary winding around one magnetic pillar and a secondary winding around another magnetic pillar, each primary winding being wired in series and each secondary winding being wired in parallel, the primary winding around the one magnetic pillar of a respective elemental transformer having a winding polarity that in response to a current generates a flux that principally returns through the other magnetic pillar of the respective elemental transformer.

The matrix transformer may comprise two elemental transformers, wherein: a first primary winding around a first magnetic pillar of a first elemental transformer has a winding polarity that in response to a current in the first primary winding generates a flux that substantially returns through a second magnetic pillar of the first elemental transformer, and a second primary winding around a third magnetic pillar of a second elemental transformer has a winding polarity that in response to a current in the second primary winding generates a flux that substantially returns through a fourth magnetic pillar of the second elemental transformer.

The first magnetic pillar may be adjacent to the second magnetic pillar, and the third magnetic pillar may be adjacent to the fourth magnetic pillar. The first pillar may further be adjacent to the fourth magnetic pillar and the third magnetic pillar may further be adjacent to the second magnetic pillar.

The planar magnetic base and the magnetic return may each have a uniform cross section area over a range of distances from a respective magnetic pillar, and the magnetic base and magnetic return may have four arms in an “X”-shape, with a magnetic pillar disposed at an end of each arm.

Each primary winding may comprise a printed circuit board trace having two turns and each secondary winding comprises a printed circuit board trace having one turn or two turns.

The matrix transformer may further comprise an electronic circuit configured to drive the primary windings over a range of operation up to 85% of a magnetic saturation value of the planar magnetic base, the magnetic return, and over a range of operation up to magnetic saturation of the plurality of magnetic pillars.

TABLE-I
Comparison of Matrix Transformer

| | Number of Elemental | | Magnetizing |
|---|---|---|---|
| | Transformers | | Inductance |
| Paper | Requirement | Core Volume | Lₘ |
| (15), (16) | Multiplicity of two | 8(D_{P} + W_{D})²h + D_{P}²L_{c} | $\frac{{n}^{2}}{}$ |
| (17), (18), (19) | Multiplicity of four | 8(D_{P} + W_{D})²h + D_{P}²L_{c} | $\frac{{n}^{2}}{}$ |
| (22) | Multiplicity of two | 8D_{P}(D_{P} + W_{D}) h + D_{P}²L_{c} | $< \frac{4 {n}^{2}}{}$ |
| Proposed | Multiplicity of two | 8D_{P}(D_{P} + W_{D}) h + D_{P}²L_{c} | $\frac{4 {n}^{2}}{}$ |

### BRIEF DESCRIPTION OF THE DRAWINGS

Together with the following detailed descriptions, the accompanying drawings illustrate a number of exemplary embodiments in addition to describing and demonstrating various aspects and/or principles set forth in the present disclosure. The accompanying drawings and the brief descriptions are provided to enable one of ordinary skill in the art to practice the various aspects and/or principles set forth in the present disclosure.

FIG. 1 illustrates example server racks and servers that include the present.

FIG. 2 illustrates an example power delivery circuit for data center servers that include the present invention.

FIG. 3 illustrates an example matrix transformer according to an embodiment of the present invention.

FIG. 4 illustrates an example flux sharing of a matrix transformer according to an embodiment of the present invention.

FIG. 5 illustrates an example flux sharing of a matrix transformer according to an embodiment of the present invention.

FIG. 6A illustrates an example matrix transformer according to an embodiment of the present invention.

FIG. 6B illustrates an example matrix transformer according to an embodiment of the present invention.

FIG. 7 illustrates an example flux sharing of a matrix transformer according to an embodiment of the present invention.

FIG. 8 illustrates an example flux sharing of a matrix transformer according to an embodiment of the present invention.

FIG. 9 illustrates an example point-of-load converter connected to a server mother board according to an embodiment of the present invention.

FIG. 10 illustrates an example point-of-load converter connected to a server mother board according to an embodiment of the present invention.

FIG. 11 illustrates an example point-of-load converter according to an embodiment of the present invention.

FIG. 12 illustrates a simplified diagram of the point-of-load converter of FIG. 11.

FIG. 13 illustrates the operation of the point-of-load converter of FIG. 11.

FIG. 14A shows a Cross Section of a single E-E Transformer with primary winding.

FIG. 14B shows a Cross Section of Transformer with distributed winding.

FIG. 14C shows a Cross Section of Transformer with modified winding.

FIG. 14D shows a Cross Section of Matrix Transformer with U-I core.

FIG. 15A shows a Single Transformer.

FIG. 15B shows a Matrix Transformer.

FIG. 16 shows a Matrix Transformer with sharing magnetic flux with adjacent pillar.

FIG. 17 shows a Flux distribution of pillar B with pillar A and C.

FIG. 18 shows a Cross Section of Matrix Transformer.

FIG. 19 shows a Matrix Transformer with proposed windings pattern.

FIG. 20 shows a Cross Section of proposed winding pattern.

### DETAILED DESCRIPTION OF THE PREFERRED EMBODIMENTS

Embodiments will be described below in more detail with reference to the accompanying drawings. The following detailed descriptions are provided to assist the reader in gaining a comprehensive understanding of the methods, apparatuses, and/or systems described herein as well as modifications thereof. Accordingly, various modifications and equivalents of the methods, apparatuses, and/or systems described herein will be apparent to those of ordinary skill in the art. Descriptions of well-known functions and constructions may be omitted for increased clarity and conciseness.

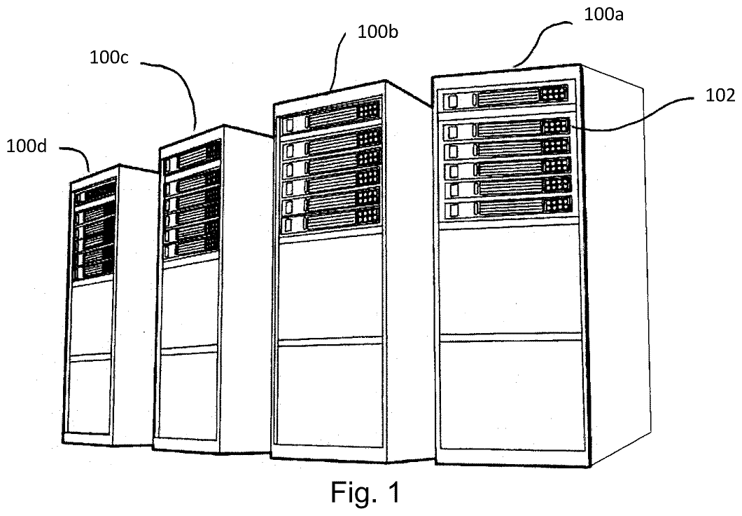

FIG. 1 illustrates example server racks 100a-d, which may be found in large numbers in a data center. Each server rack 100 includes multiple servers 102. Each of the servers 102 includes a point-of-load power converter according to an embodiment of the present invention, as described in more detail below.

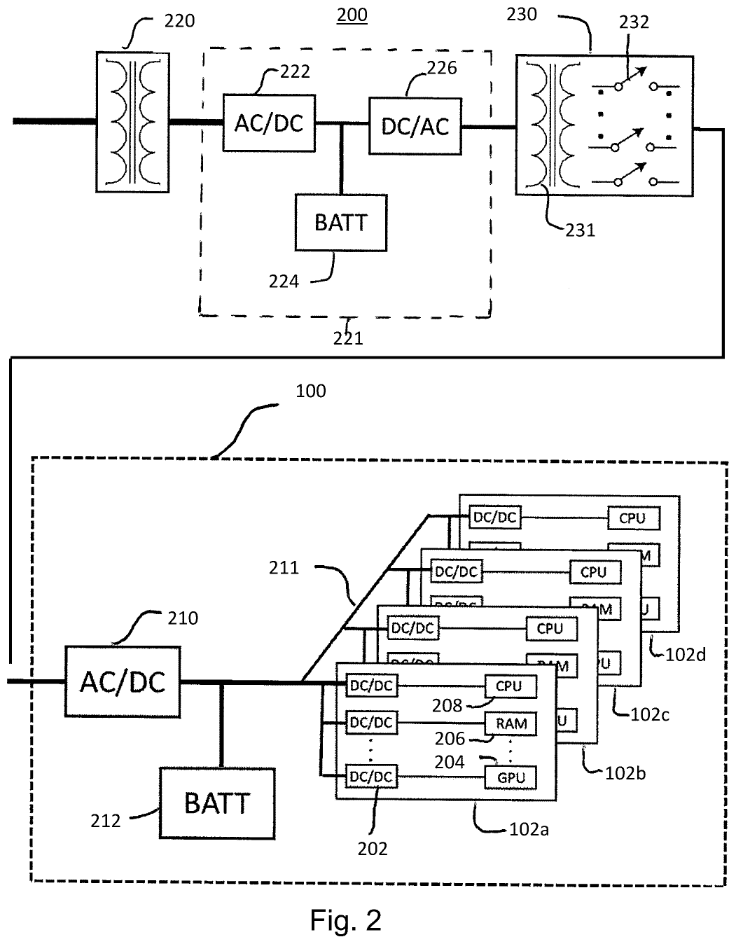

FIG. 2 illustrates an example power delivery circuit 200 for data center server racks 100, each of which includes a plurality of servers 102. As shown in FIG. 2, power delivery circuit 200 includes a transformer 220, an uninterruptable power supply 221, and a power distribution unit 230. In embodiments, the transformer 220 may be used, for example to step the supply voltage from 4160 Vac down to 480 Vac. The uninterruptable power supply 221 includes an AC/DC converter 222, a battery 224, and a DC/AC converter 226. Power distribution unit 230 includes a transformer 231 and a plurality of server feeder circuit 232, each of which provides power to a server rack 100 as shown in FIG. 2.

As shown in FIG. 2, each feeder circuit 232 of power distribution unit 230 provides uninterrupted power from uninterruptable power supply 221 to an AC/DC power converter 210 of a server rack 100. AC/DC power converter 210 in turn provides DC power to a DC power distribution circuit 211. In embodiments, the voltage of DC power distribution circuit 211 is a nominal 48 Vdc. The DC power distribution circuit 211 provides DC power to a plurality of point-of-load (DC/DC) power converters 202 according to the present invention. These point-of-load power converters are used to power, for example, various computer/server devices such as a graphics processing unit (GPU) 204, random access memory (RAM) 206 and/or a computer processing unit (CPU) 208. Other devices can also be powered form point-of-load power converter 202.

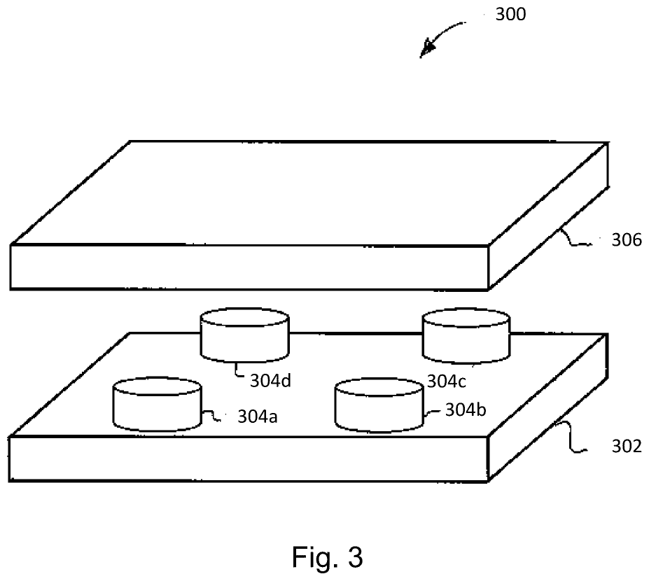

FIG. 3 illustrates an example matrix transformer 300 according to an embodiment of the present invention. Matrix transformer 300 includes a magnetic base 302, four magnetic pillars 304a-d, and a magnetic cap 306.

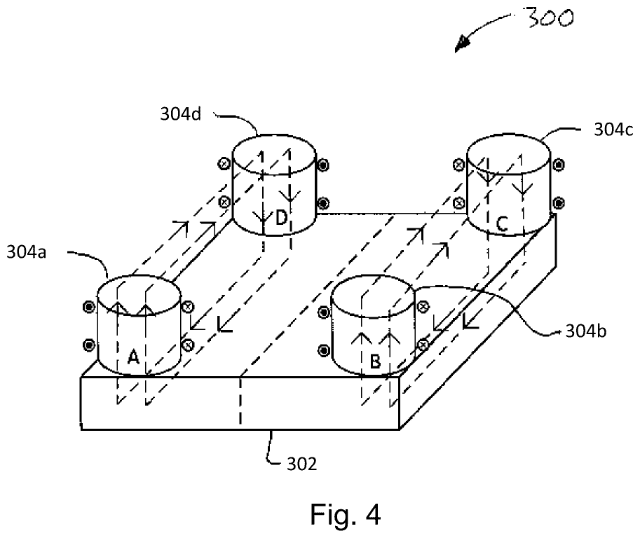

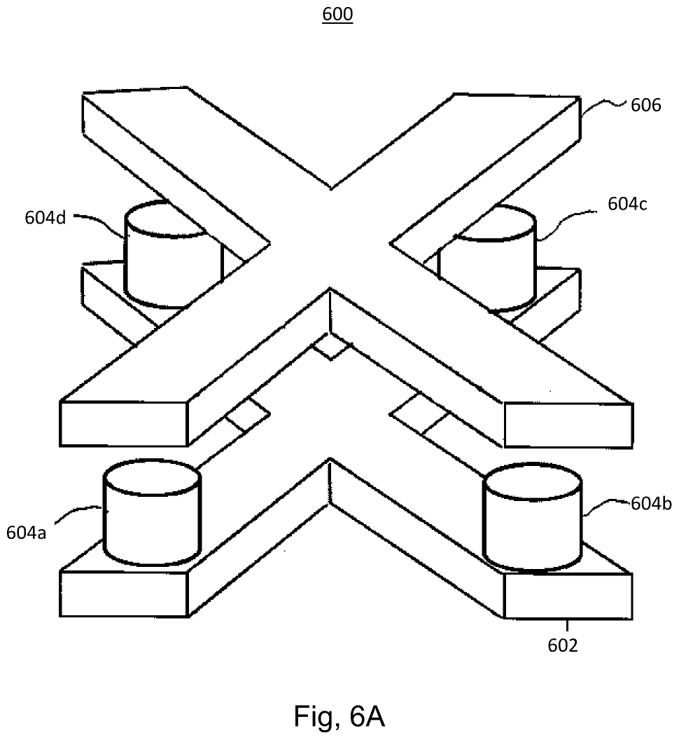

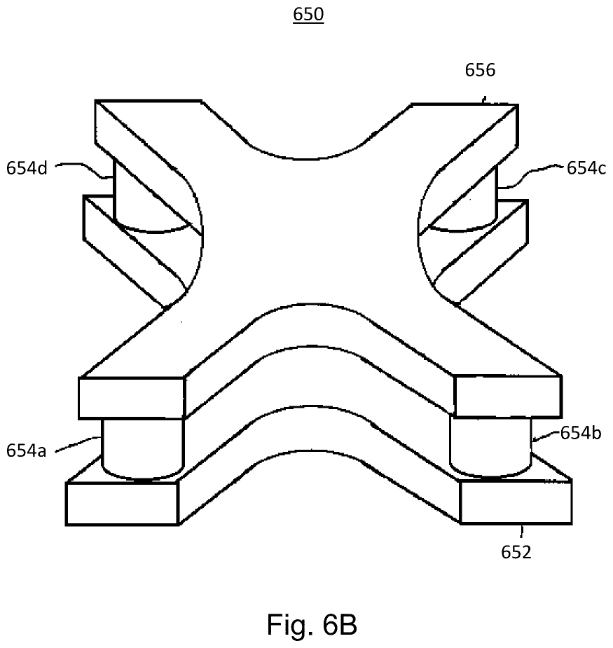

FIG. 4 illustrates an example flux sharing of matrix transformer 300 according to an embodiment of the present invention. FIG. 4 shows matrix transformer 300 with the magnetic cap 306 removed so that the flux sharing among pillars 304a-d can be more easily seen. As shown in FIG. 4, the magnetic pillars 304 are wound so that in an embodiment flux is shared between adjacent pillars 304a and 304d, and between adjacent pillars 304b and 304c. This sharing of flux between only two adjacent pillars 304 as shown in FIG. 4 is different than that of a traditional matrix transformer in which the flux flowing through a particular pillar is shared with multiple pillars. As described in more detail below with reference to FIGS. 6-8, the flux sharing in matrix transformers according to the present invention allows the base and the cap of the matrix transformer to be made smaller and with less magnetic material than that of a traditional matrix transformer, and to have better properties than that of a traditional matrix transformer. The winding patterns of the coils around each pillar 304 are indicated in FIG. 4 by the dots and the crosses next to each pillar 304.

It is a feature of the present invention that it increases the mutual inductance of matrix transformer 300 compared to that of a traditional matrix transformer. As shown in FIG. 4, all the windings are connected in series in order to increase the overall magnetizing inductance. The windings pattern is such that the flux of one pillar is shared with only one adjacent pillar rather than with two adjacent pillars as is the case in a traditional matrix transformer. As shown in FIG. 4, the flux of pillar 304b completes its path through pillar 304c only. Similarly, the flux of pillar 304a passes through pillar 304d only. Current directions through these windings are shown by ‘dot’ and ‘cross’ notation and accordingly the flux direction is shown. Since the magnetic path completes through two pillars 304, along with cap 306 and base 302 only, the inductance value can be readily calculated.

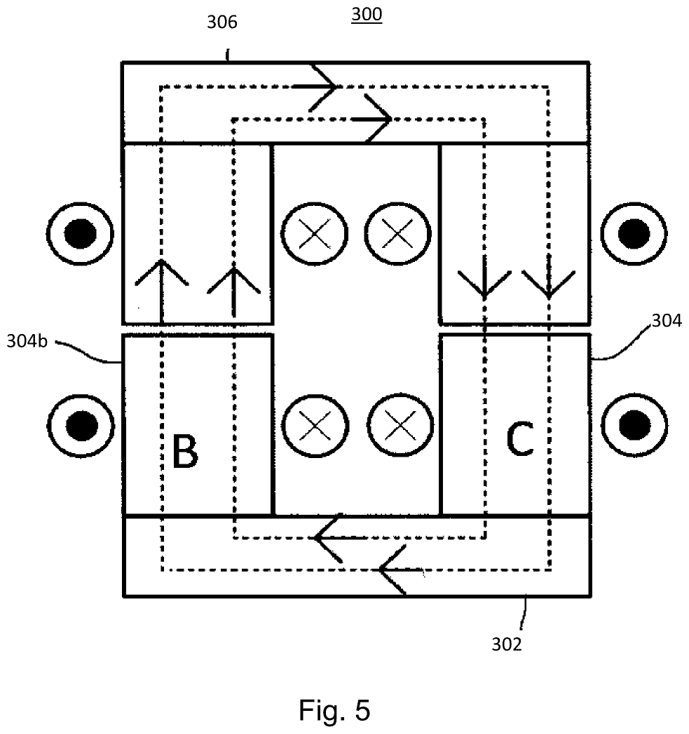

FIG. 5 further illustrates an example flux sharing of matrix transformer 300 according to an embodiment of the present invention. FIG. 5 shows how, in an embodiment, the flux flows from magnetic base 302 up through magnetic pillar 304b into magnetic cap 306. From magnetic cap 306, the flux flows down through pillar 304c and returns to base 302. The winding patterns of the coils around pillar 304b and 304c are indicated by the dots and the crosses next to each pillar 304.

Referring to FIG. 5, In an embodiment the total turns along the magnetic path shown in FIG. 5 is four including pillars 304b and 304c. The corresponding inductance is 16/R. Likewise, pillars 304a and 304d contribute the same value of inductance. Since the primary windings are connected in series, the total inductance value is 32/R. Thus, the pattern of matrix transformer 300 offers two times the magnetizing inductance of a traditional matrix transformer having the same number of total turns. Also, the flux density of each pillar 304 is the same as in some traditional matrix transformers. Since core loss is proportional with core volume, the core geometry of a matrix transformer according to the present invention can lead to a reduction of the overall matrix transformer core volume as shown for example in FIGS. 6a and 6B, and as explained in more detail below with reference to FIG. 8.

FIG. 6A illustrates an example x-shaped matrix transformer 600 according to an embodiment of the present invention. X-shaped matrix transformer 600 includes an x-shaped magnetic base 602, four magnetic pillars 604a-d, and an X-shaped magnetic cap 606.

FIG. 6B illustrates an example matrix transformer 650 according to an embodiment of the present invention. Matrix transformer 600 includes a magnetic base 652 that has four concave sides, four magnetic pillars 654a-d, and a magnetic cap 656 that has four concave side. Matrix transformer 650 is similar to X-shaped matrix transformer 600 except that some or all of the abrupt edges of matrix transformer 600 have been smoothed or rounded.

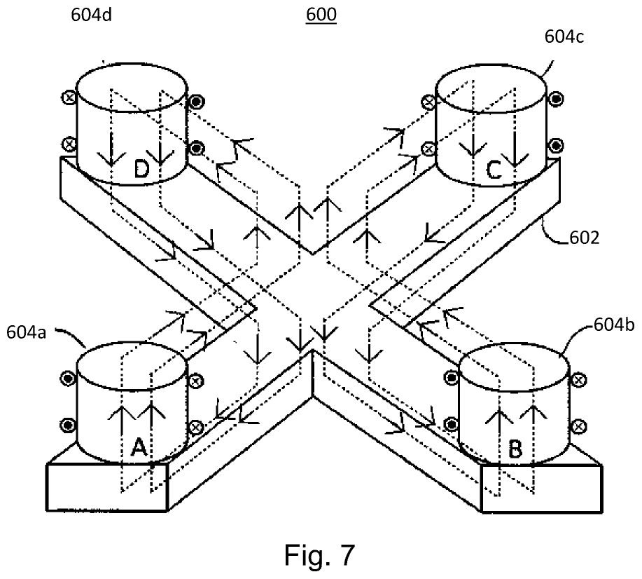

FIG. 7 illustrates an example flux sharing of x-shaped matrix transformer 600 according to an embodiment of the present invention. FIG. 7 shows x-shaped matrix transformer 600 with the magnetic cap 606 removed so that the flux sharing among pillars 604a-d can be more easily seen. As shown in FIG. 7, the magnetic pillars 604 are wound so that in an embodiment flux is shared between adjacent pillars 604a and 604d, and between adjacent pillars 604b and 604c. This sharing of flux between only two adjacent pillars 604 as shown in FIG. 7 is different than that of a traditional matrix transformer in which the flux flowing through a particular pillar is shared with multiple pillars. As described herein, the flux sharing in matrix transformers according to the present invention allows the base and the cap of the matrix transformer to be made smaller and with less magnetic material than that of a traditional matrix transformer, as demonstrated by x-shaped base 602 and x-shaped cap 606, and to have better properties than that of a traditional matrix transformer. The winding patterns of the coils around each pillar 604 are indicated in FIG. 7 by the dots and the crosses next to each pillar 604.

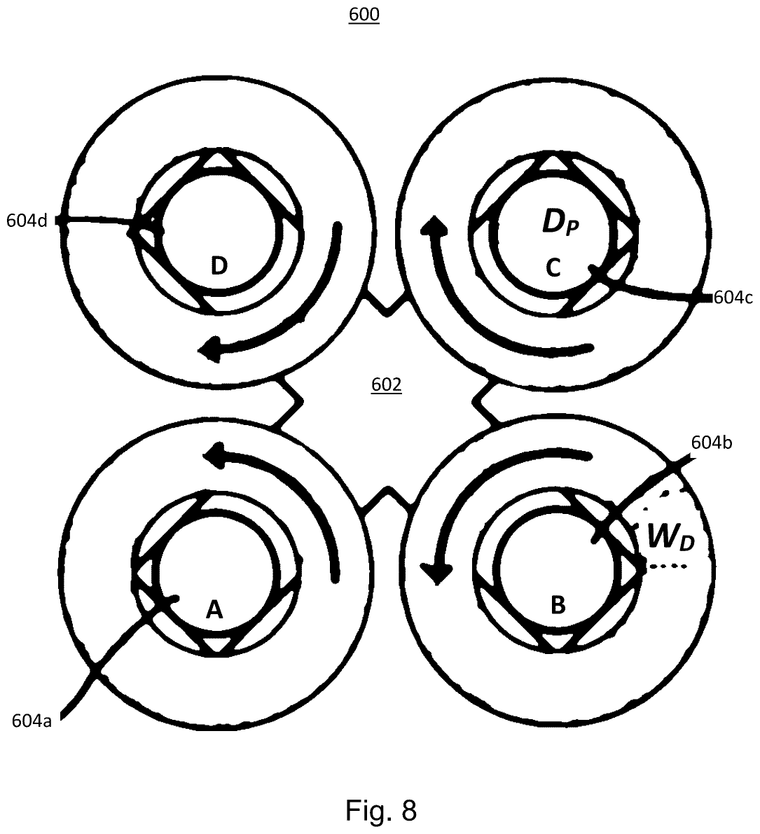

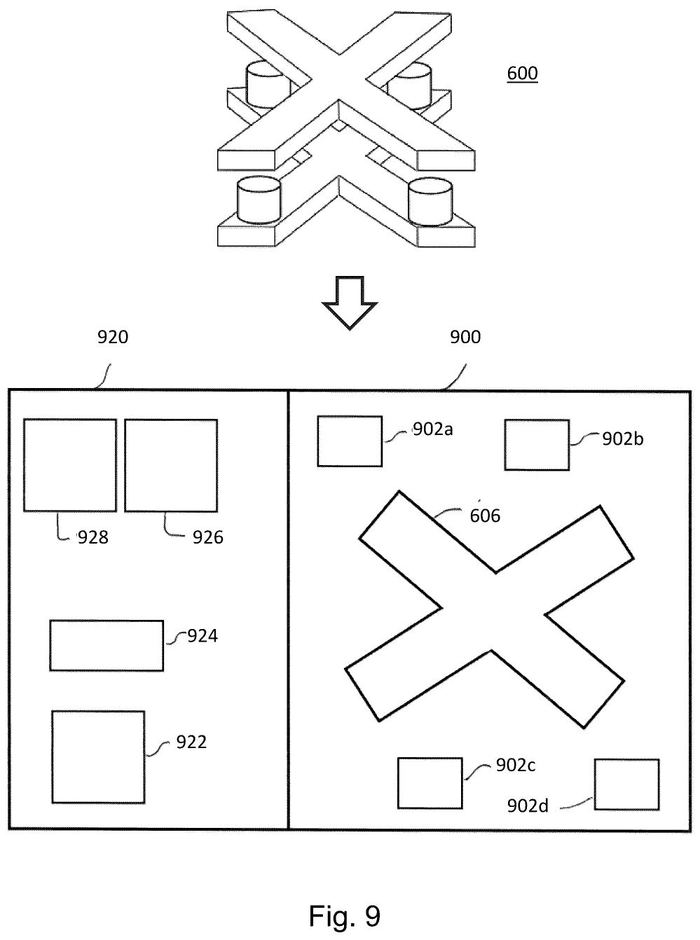

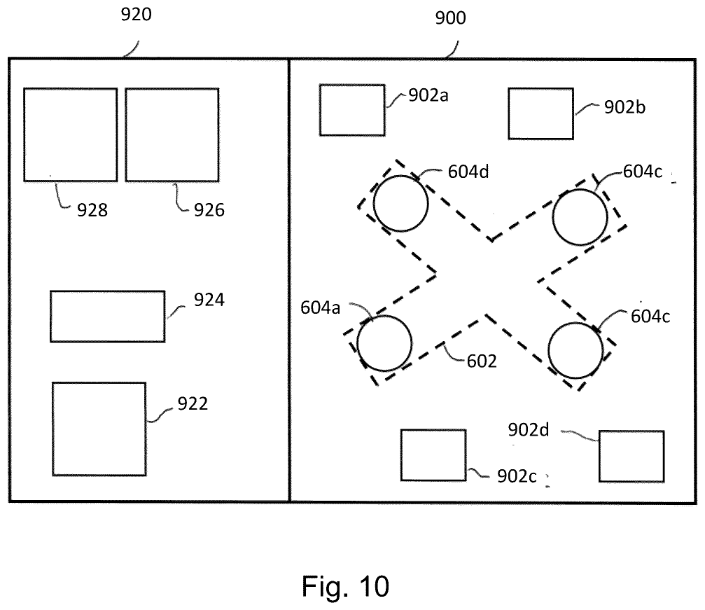

FIG. 8 further illustrates the coil windings of x-shaped matrix transformer 600 according to an embodiment of the present invention. As shown in FIG. 8, an arrow around each pillar 604a-d shows the direction in which the coils are wound around each pillar. In embodiments, the coil windings comprise metal traces on a printed circuit board, and the x-shaped matrix transformer is fitted to the printed circuit board as shown in FIGS. 9-10.

As described above, since core loss is proportional with core volume, the core geometry of a matrix transformer according to the present invention can lead to a reduction of the overall matrix transformer core volume. In embodiments, the total reduction in core volume, V_{reduced}, is given by the following equation:

$${V}_{r e d u c e d} = h ( 8 {{W}_{D}}^{2} + 4.686 {D}_{P} {W}_{D} - 1.313 {D}_{P} ) \qquad ( 4 )$$

where, h, W_{D} and D_{P} are the thickness of the core plate, the winding width, and the diameter of the pillar, respectively.

In embodiments, with a high load demand W_{D} increases, and D_{P} becomes smaller with a low output voltage demand. Hence, as will be understood by persons skilled in the relevant art(s) given the description herein, the present invention allows for a matrix transformer having a significantly reduced core volume compared to a traditional matrix transformer.

FIG. 9 illustrates an example point-of-load converter 900 connected to a server mother board 920 according to an embodiment of the present invention. Point-of-load converter 900 includes an X-shaped matrix transformer 600 and four switching devices or synchronous rectifiers 902a-d. In embodiments, the base of X-shaped matrix transformer 600 has four attached pillars, and these pillars extend through holes in the printed circuit board of the point-of-load converter 900. The cap 606 of matrix transformer 600 is than attached to the tops of the four pillars such that the base is on one side of the printed circuit board and the cap 606 is on the other side of the printed circuit board. In embodiments, matrix transformer 600 has a low heigh profile.

Server mother board 920 includes multiple microelectronic devices such as a computer processing unit (CPU) 922, memory 924, and chips 926 and 928, one of which might be a graphics processing unit (GPU). In embodiments, these microelectronic devices may require a supply voltage of about 1-2 volts. For example, a CPU might require a supply voltage of about 1.8 volts, the memory might require a supply voltage of about 1.2 volts, and the GPU might require a supply voltage of about 1 volt. In embodiments, the point-of-load converters produce these required supply voltages from an input voltage of about 48 volts. In other embodiments, other input voltages and supplied voltages may be used.

In embodiments, the point-of-load converter 900 is a separate printed circuit board from the server mother board, and the point-of-load converter 900 has a connected that plugs into a connector on server mother board 920.

FIG. 10 further illustrates example point-of-load converter 900 connected to server mother board 920 according to an embodiment of the present invention. In FIG. 10, the cap 606 of X-shaped matrix converter 600 has been removed so that one may see the four pillars 604a-d and the X-shaped magnetic base 602 of X-shaped matrix converter 600.

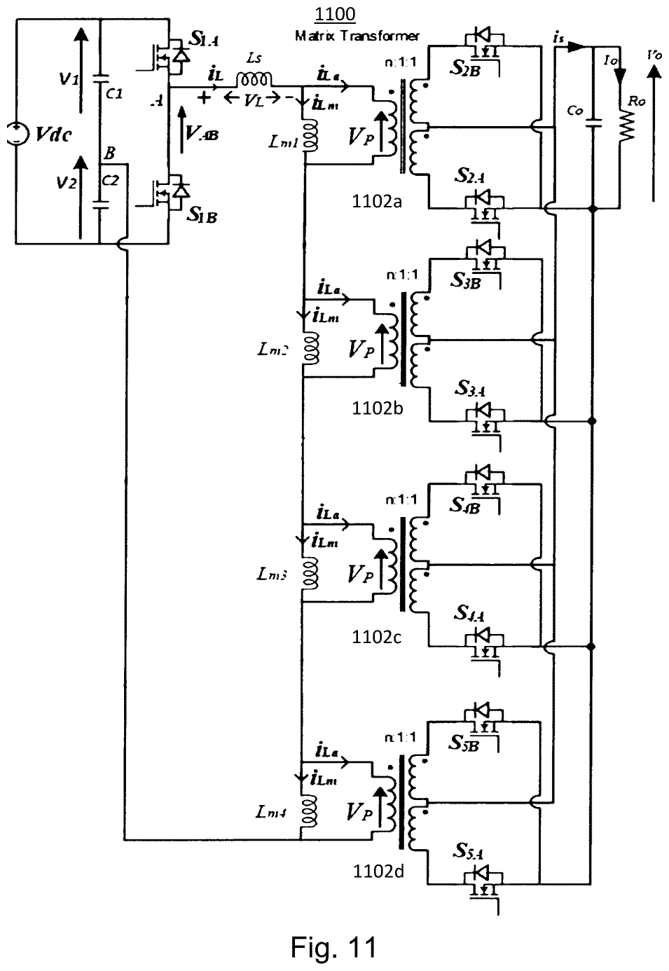

FIG. 11 illustrates an example point-of-load converter 1100 that includes a matrix transformer according to an embodiment of the present invention. The matrix transformer of point-of-load converter 1100 has four pillars 1102a-d. In embodiments, the matrix transformer is an N:1:1 transformer, where N is selected based on the input source voltage (V_{dc}) and the desired output source voltage (Vₒ).

In embodiments, point-of-load converter 1100 is an inductive link half-bridge converter. As depicted, point-of-load converter 1100 includes a half-bridge converter followed by an inductor to feed ac input to a high frequency transformer and then a synchronous rectifier to rectify the ac output to a desired dc output. Here, power transfer is done by energizing and deenergizing the inductor Lₛ. Two dc link capacitors, C₁ and C₂, are connected in series across the input voltage V_{dc}. Voltage across the capacitors C₁ and C₂ are V1 and V2 respectively. During steady state, it can be considered that both the voltages are same. On the secondary side, capacitor Cₒ is used to filtered out the ac current ripple of the rectified current. This results in lower electro-magnetic emissions. In addition, it can enable a high degree of integration in the magnetic parts, enabling the design of converters with higher efficiency and power density.

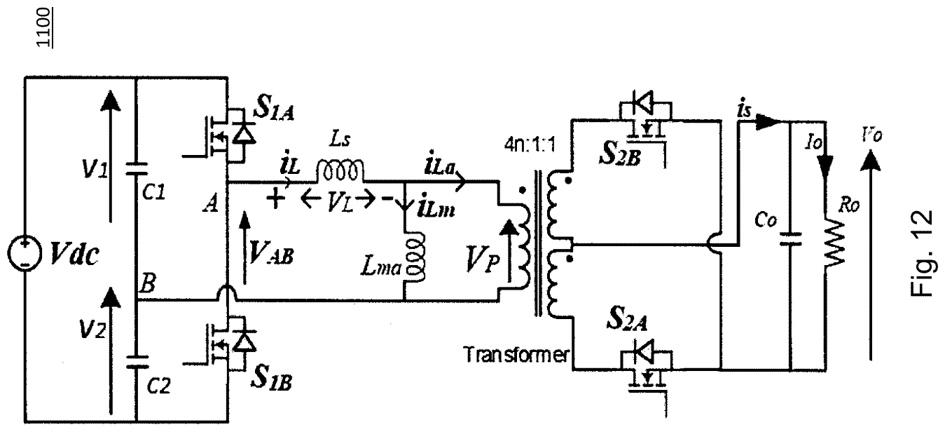

As known to persons skilled in the relevant art(s), all transformers have a finite magnetizing inductance, Lₘ. This magnetizing inductance causes circulating current in the primary side of point-of-load converter 1100. As shown in FIG. 11, the magnetizing inductances Lₘ₁, Lₘ₂, Lₘ₃ and Lₘ₄ are the individual magnetizing inductance of each elemental transformer shown in FIG. 11. These individual elemental transformers may be considered to have the same magnetizing inductance and active current component, i_{La}, flowing through each of the elemental transformers as shown in FIG. 11. Thus, the summation of magnetizing inductances Lₘ₁, Lₘ₂, Lₘ₃ and Lₘ₄ is equal to Lₘₐ as depicted in FIG. 12.

In order to better understand the present invention, FIG. 12 is a simplified diagram of point-of-load converter 1100 shown in FIG. 11. In FIG. 12, in order to focus on the effects of Lₘ on the converter, the matrix transformer is represented by an equivalent single transformer (4n:1:1), and followed by a synchronous rectifier. Lₘₐ is the magnetizing inductance of the shown center tap transformer and i_{Lm} is the magnetizing current flowing through it. Current, i_{La}, is the active component responsible for power transfer to the load. Current i_{L} is the summation of i_{La} and i_{Lm} and flow through Lₛ and devices S_{1A} and S_{IB}. This phenomenon can not only increase device ratings, but it can also cause switching losses of the primary side of the point-of-load converter without contributing to any additional power transfer. This can cause a degradation of light load efficiency of the converter. Due to high conduction loss in diode rectification, synchronous rectification is preferred in low voltage high current applications.

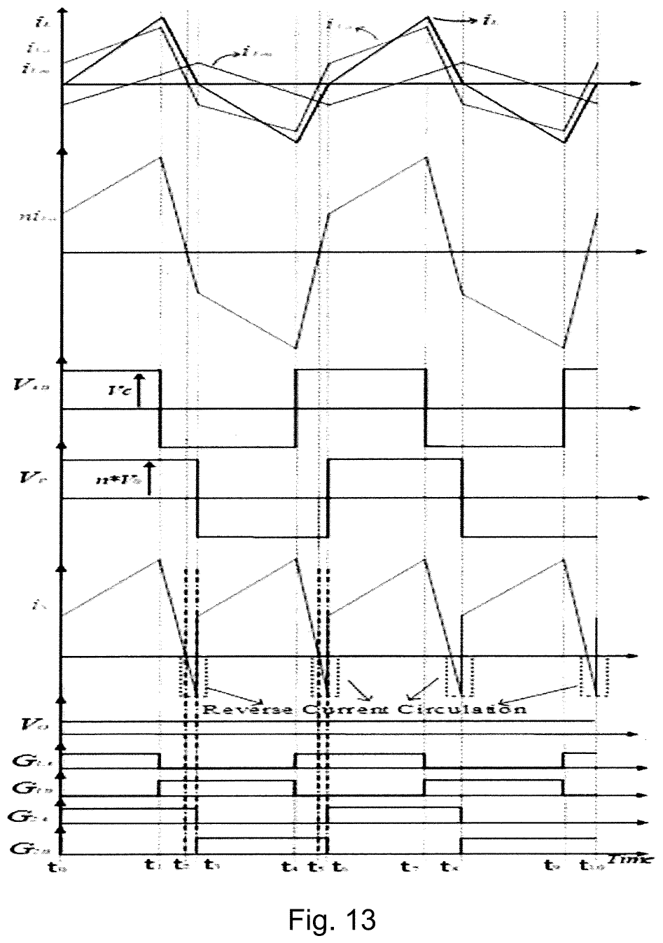

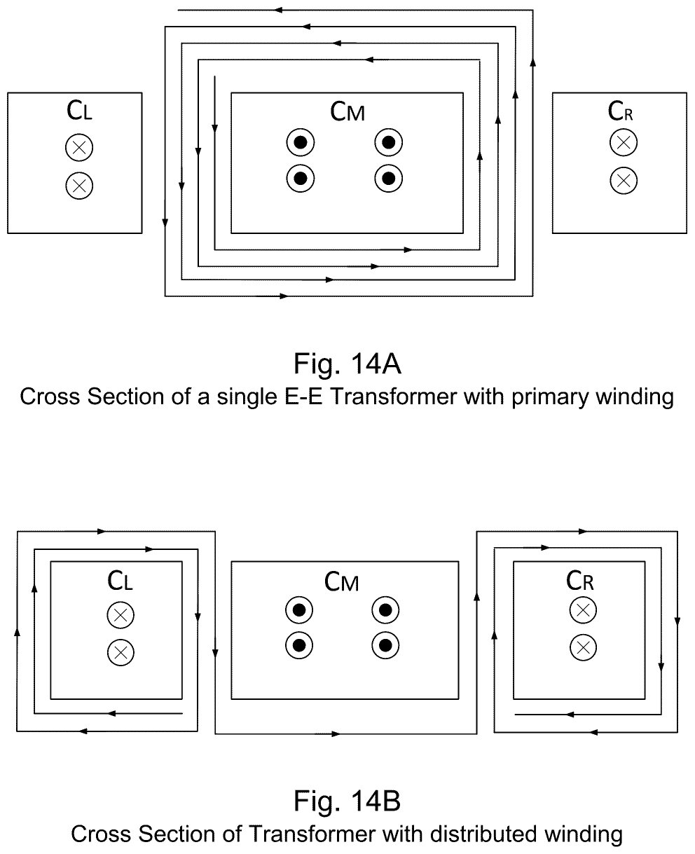

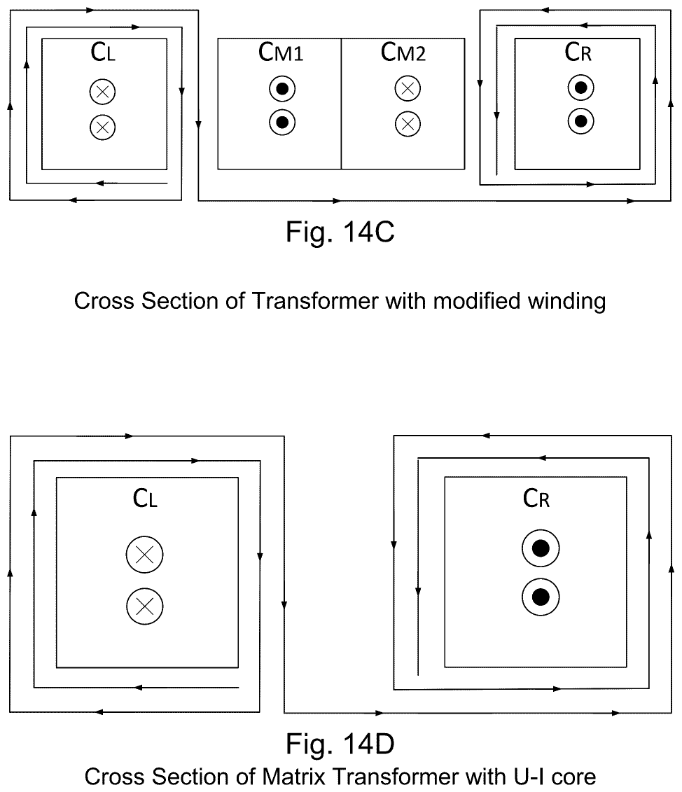

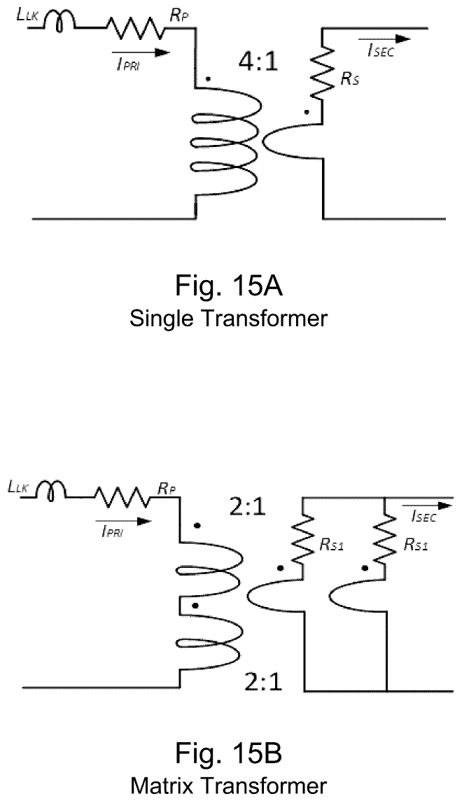

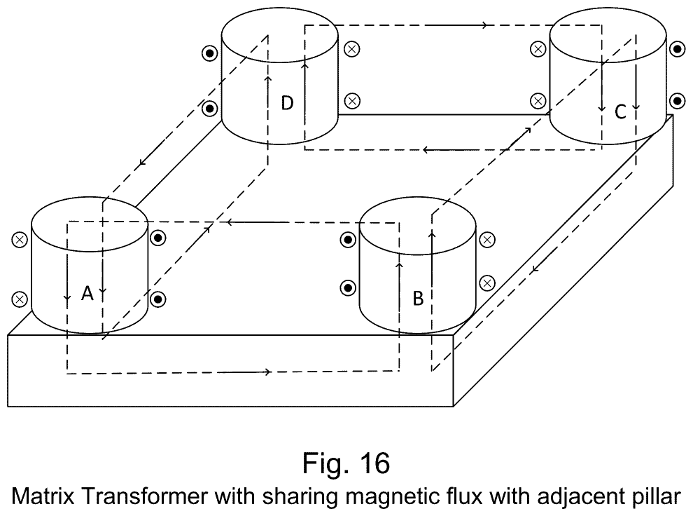

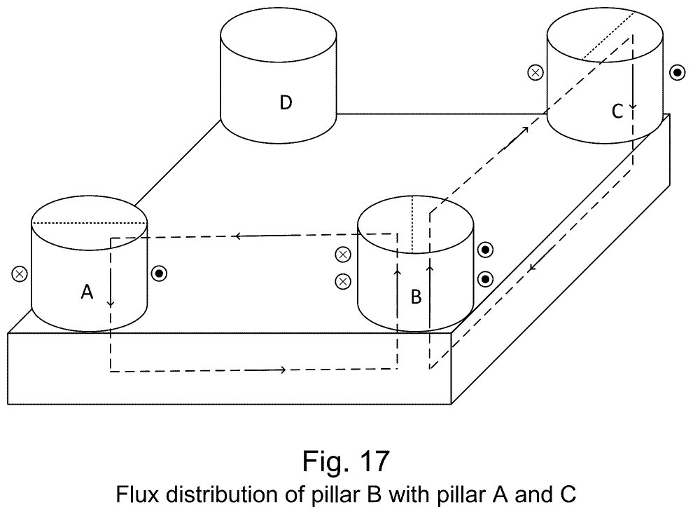

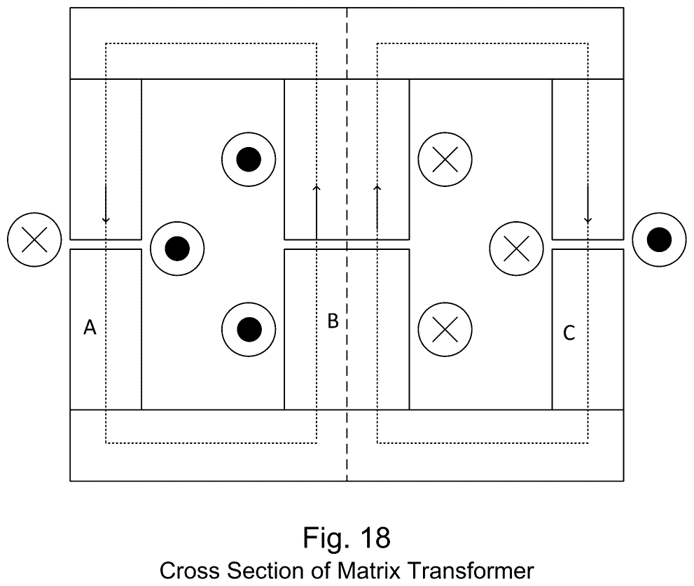

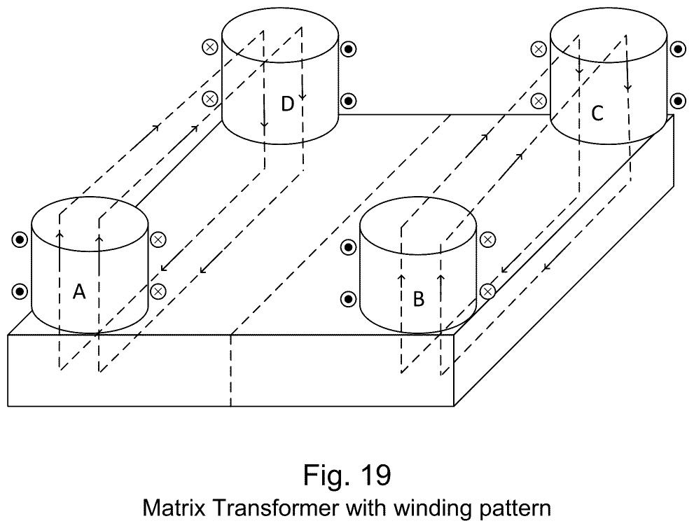

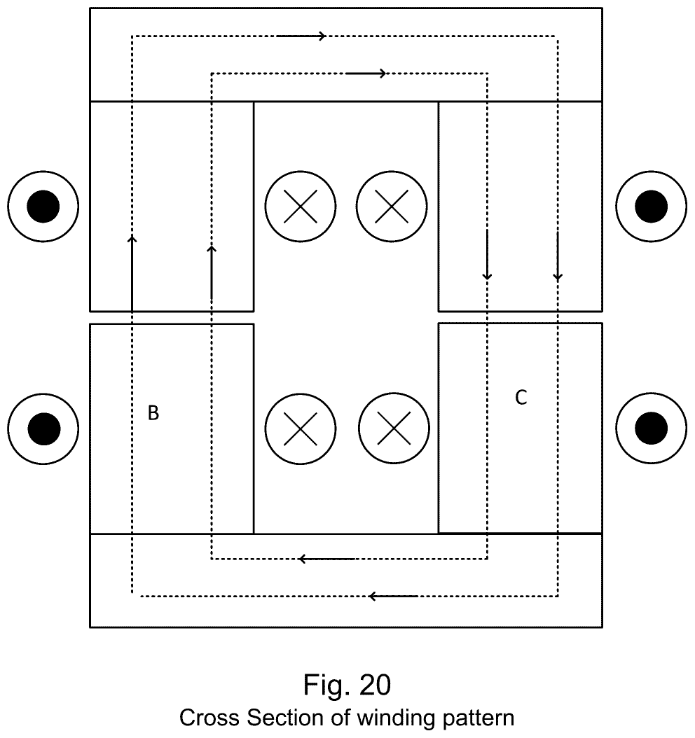

FIG. 13 illustrates various waveforms that depict the operation of the point-of-load converter 1100 of FIG. 11. In FIG. 13, circuit waveforms with smaller Lₘ are shown. With a smaller value of Lₘ, i_{Lm} becomes significant and leads to asynchronous switching instants between primary and secondary side devices. This leads to challenges in synchronous rectification gate-pulse generation. To solve this, synchronous side gate pulses are generated by sensing comparatively smaller series inductor current i_{L} only. While i_{L} is positive, S_{2A} and S_{2B} are turned-on and turned-off respectively. When i_{L} is negative, S_{B} and S_{2A} are turned-on and turned-off, respectively.

As shown in FIG. 12, the circuit for point-of-load converter 1100 consists of a half-bridge converter followed by a synchronous rectifier at the output end. Lₛ is the series inductor, and the dc link capacitors, C₁ and C₂, have voltages of V₁ and V₂ respectively. Together they are connected in series across the input voltage, V_{dc}. At steady state, V₁ as well as V₂ are the same and equal to V_{c}. At the output end, capacitor Cₒ is connected across the load, Rₒ.

As shown in FIG. 13, G_{1A}, G_{IB}, G_{2A} and G_{2B} are the gate pulses to the switches SlA, S_{IB}, S_{2A} and S_{2B} respectively. The circuit operation and waveforms shown in FIG. 13 are described in details in T. S. Sasmal, K. Yenduri and P. Das, “Single-stage saturable inductive-link half-bridge point of load converter,” 2021 IEEE Energy Conversion Congress and Exposition (ECCE), 2021, pp. 2042-2047, doi: 10.1109/ECCE47101.2021.9595359, which is incorporated herein by reference in its entirety. In this reference, the impact on synchronous rectification gate pulse generation with a smaller value of Lₘ is explained in detail. The flow of reverse direction current is explained with reference to FIG. 13 and the two cases that follow.

Case I (t₂-t₃): At time to, current i_{L} starts increasing with a fixed positive slope, and at time t₁ starts decreasing with a fixed negative slope and becomes zero at t₃. Current i_{L} is the summation of i_{La} and i_{Lm}. Active component current i_{La} becomes zero at time t₂. After time t₂, this becomes negative and keeps on decreasing with the same slope until it becomes equal to the absolute value of i_{Lm}. Through-out the time period t₀-t₃, gate pulse G_{2A} remains high as it is commanded by i_{Lm}. As a result, is becomes negative during the interval t₂-t₃. This induces a large mismatch between the zero crossing of i_{La} and i_{L} with smaller Lₘ. Since i_{S} is n times i_{La} (for each elemental transformer) as shown in FIG. 13, it causes a considerable amount of reverse current circulation during this interval.

Case II (t₅-t₆): From time instant t₃, i_{L} starts decreasing with a fixed negative slope and at time t₄ it becomes negative maximum. Thereafter i_{L} starts increasing with a fixed positive slope and becomes zero at t₆. Current i_{La} becomes zero at time t₅. After time t₅, it becomes positive and keeps on rising with the same slope till it becomes equal to the absolute value of i_{Lm}. During the time period t₃-t₆, gate pulse G_{2B} remains high as it is directed by i_{L}. As a result, is remains negative for the interval t₅-t₆. Similar to the previous case, it causes reverse current circulation during this interval. In this way, at the rectifier end, i_{S} flows in a reverse direction for a small duration as shown with the dotted box in the FIG. 13. All these lead to extra power demand from the source as well as higher device ratings. Power loss, Pᵣₑᵥ due to reverse current circulation is given by the following equation:

$${P}_{r e ν} = \frac{{( {n V}_{o} )}^{3} {L}_{s} {T}_{s}}{16 {{L}_{m}}^{2} ( {n V}_{o} + {V}_{dc} / 2 )} \qquad ( 5 )$$

where n, Vₒ, L_{S}, T_{S} and V_{dc} are the turns ratio of transformer, output voltage, series inductor at primary side, switching time period, and dc input voltage to the converter respectively. From the above equation, one can see that the matrix transformer of the present invention reduces the power loss by a factor of four compared to a traditional matrix transformer, such as the ones described in (1) C. Fei, F. C. Lee and Q. Li, “High-Efficiency High-Power-Density LLC Converter With an Integrated Planar Matrix Transformer for High-Output Current Applications,” in IEEE Transactions on Industrial Electronics, vol. 64, no. 11, pp. 9072-9082, November 2017, doi: 10.1109/TIE.2017.2674599; and (2) C. Fei, F. C. Lee and Q. Li, “High-efficiency high-power-density 380V/12V DC/DC converter with a novel matrix transformer,” 2017 IEEE Applied Power Electronics Conference and Exposition (APEC), 2017, pp. 2428-2435, doi: 10.1109/APEC.2017.7931039; both of which are incorporated herein by reference in their entireties.

With the aforementioned simpler secondary side gate-pulse generation strategy, zero current switching of synchronous side devices are not achievable with smaller Lₘ. Turning-off instants of synchronous side gate pulses occur at actual zero crossing of i_{L} as shown in FIG. 13. With a large value of i_{Lm}, is becomes significant through the devices S_{2A} and S_{2B} during turn-off. This causes a deviation from soft-switching at the secondary side of the converter. With a small value of i_{Lm}, the zero crossings of i_{L} do not differ significantly with i_{La}, and results in a simpler and more economical solution as described herein.

As described herein, the present invention provides an integrated matrix transformer for point-of-load converters, and applications thereof. Matrix transformers according to the present invention have both a smaller surface area and therefore a reduce core volume, which lowers core losses. The matrix transformers and winding patterns described herein offer larger magnetizing inductances which aid in attaining better accuracy for the effective gate pulse generation on the synchronous side of the point-of-load converters presented. This mitigates the power reversal problem present in traditional point-of-load converters using traditional matrix transformers. A reduction of circulating current in primary side is also accomplished. As will be understood by persons skilled in the relevant art(s) given the description herein, the present invention is well adapted for point-of-load converter applications that require a low output voltage and high power, and this is achieved without affecting the mechanical stability of the magnetics.

Those skilled in the relevant art(s) will readily appreciate that various adaptations and modifications of the exemplary embodiments described above can be achieved without departing from the scope and spirit of the present disclosure. Therefore, it is to be understood that, within the scope of the appended claims, the teachings of the disclosure may be practiced other than as specifically described herein.

What is claimed is:

1. A matrix transformer, comprising:
a set of elemental transformers grouped in pairs, each elemental transformer comprising a core, a primary winding and a secondary winding,
the primary windings of all the elemental transformers being wired in series and all of the secondary windings being wired in parallel,
the cores of the plurality of elemental transformers being magnetically coupled by an upper magnetically permeable member and a lower magnetically permeable member, and
the primary windings having a winding polarity such that flux from the primary winding around one core of a respective elemental transformer principally returns through the upper magnetically permeable member and the lower magnetically permeable member to the other core of the respective elemental transformer.

2. The matrix transformer according to claim 1, wherein the upper magnetically permeable member and the lower magnetically permeable member each have a uniform cross section area over a range of distances from a respective core.

3. The matrix transformer according to claim 1, wherein the matrix transformer has two pairs of elemental transformers and four cores.

4. The matrix transformer according to claim 3, wherein each primary winding has two turns.

5. The matrix transformer according to claim 3, wherein the upper magnetically permeable member and the lower magnetically permeable member are “X” shaped, with a respective core disposed at an end of leg of the X shape.

6. The matrix transformer according to claim 1, wherein a flux from a core of a respective elemental transformer has a return path through a single other core.

7. A matrix transformer, comprising:
a plurality of magnetic pillars;
a magnetic base;
a magnetic cap;
the magnetic base and the magnetic cap forming magnetic circuits comprising the plurality of magnetic pillars; and
a set of windings wired in series around a first subset of the magnetic pillars, and a set of windings wired in parallel around a second subset of the magnetic pillars,
wherein a polarity of the windings, the plurality of magnetic pillars, the magnetic base, and the magnetic cap are together configured such that a flux in one magnetic pillar has a return path substantially through one other magnetic pillar.

8. The matrix transformer of claim 7, wherein the magnetic base has four concave sides and the magnetic cap has four concave sides.

9. The matrix transformer of claim 7, wherein the magnetic base and the magnetic cap are each X-shaped.

10. The matrix transformer of claim 7, comprising two pairs of elemental transformers each paving a pair of magnetic pillars.

11. The matrix transformer of claim 10, wherein the two pairs of elemental transformers comprise a first magnetic pillar, a second magnetic pillar, a third magnetic pillar, and a fourth magnetic pillar, wherein a flux from the magnetic base passing through the first magnetic pillar has a return path through the magnetic cap and the second magnetic pillar, and a flux from the magnetic base passing through the third magnetic pillar has a return path through the magnetic cap and the fourth magnetic pillar.

12. The matrix transformer of claim 11, wherein the first magnetic pillar is adjacent to the second magnetic pillar and the third magnetic pillar is adjacent to the fourth magnetic pillar.

13. The matrix transformer of claim 11, wherein the set of windings comprise circuit board traces.

14. A matrix transformer, comprising:
a planar magnetic base, having at least four arms and a central junction region;
a plurality of magnetic pillars, a respective magnetic pillar on each arm extending upward from a plane of the planar magnetic base; and
a magnetic return, completing a magnetic circuit including the planar magnetic base and the plurality of magnetic pillars,
each respective magnetic pillar being surrounded by a wire loop, and being arranged as a plurality of sets of elemental transformers each having a primary winding around one magnetic pillar and a secondary winding around another magnetic pillar, each primary winding being wired in series and each secondary winding being wired in parallel, the primary winding around the one magnetic pillar of a respective elemental transformer having a winding polarity that in response to a current generates a flux that principally returns through the other magnetic pillar of the respective elemental transformer.

15. The matrix transformer of claim 14, comprising two elemental transformers, wherein:
a first primary winding around a first magnetic pillar of a first elemental transformer has a winding polarity that in response to a current in the first primary winding generates a flux that substantially returns through a second magnetic pillar of the first elemental transformer, and
a second primary winding around a third magnetic pillar of a second elemental transformer has a winding polarity that in response to a current in the second primary winding generates a flux that substantially returns through a fourth magnetic pillar of the second elemental transformer.

16. The matrix transformer of claim 15, wherein the first magnetic pillar is adjacent to the second magnetic pillar, and the third magnetic pillar is adjacent to the fourth magnetic pillar.

17. The matrix transformer according to claim 14 wherein the planar magnetic base and the magnetic return each have a uniform cross section area over a range of distances from a respective magnetic pillar, and the magnetic base and magnetic return have four arms in an “X”-shape, with a magnetic pillar disposed at an end of each arm.

18. The matrix transformer according to claim 14, wherein each primary winding comprises a printed circuit board trace having two turns and each secondary winding comprises a printed circuit board trace having one turn.

19. The matrix transformer according to claim 14, wherein each primary winding comprises a printed circuit board trace having two turns and each secondary winding comprises a printed circuit board trace having two turns.

20. The matrix transformer according to claim 14, further comprising an electronic circuit configured to drive the primary windings over a range of operation up to 85% of a magnetic saturation value of the planar magnetic base, the magnetic return, and over a range of operation up to magnetic saturation of the plurality of magnetic pillars.
